(19) United States
(12) Patent Application Publication
(10) Pub. No.: US 2021/0192412 A1
(43) Pub. Date: Jun. 24, 2021

(54) Cognitive Intelligent Autonomous Transformation System for actionable Business intelligence (CIATSFABI)

(71) Applicant: Sankar Krishnaswamy, Round Rock, TX (US)

(72) Inventor: Sankar Krishnaswamy, Round Rock, TX (US)

(21) Appl. No.: 17/187,761

(22) Filed: Feb. 27, 2021

Related U.S. Application Data
(63) Continuation-in-part of application No. 16/024,061, filed on Jun. 29, 2018, now abandoned.
(60) Provisional application No. 62/591,007, filed on Nov. 27, 2017.
(60) Provisional application No. 62/599,448, filed on Dec. 15, 2017.

(51) Int. Cl. G06Q 10/06; G06Q 10/10; G06Q 30/02; G06Q 30/00; G06N 3/08

(52) U.S. Cl. CPC G06Q 10/06375; G06Q 10/101; G06Q 10/103; G06N 3/08; G06Q 30/0201; G06Q 10/06316; G06Q 30/018; G06Q 10/06393

(57) ABSTRACT

A Utility patent with new concepts, methods, a comprehensive step-by-step procedure/system to produce semi-autonomous, self-curing customizable Cognitive Intelligent Autonomous Transformation System aided by Digital Assistants based on AI, Machine Learning enhanced RPA, natural language processing, speech recognition and image recognition with Deep Learning and Neural networks, that will transform an existing business system to the latest version supported by vendor for the industry with superior process automation. By Combining AI and cognitive computing in a single operating environment using the same sets of data—configuration data, Master Data, Transaction Data and historical transaction data, we propose to revolutionize existing customer's information systems to be a self-evolving cognitive intelligent automation systems where it not only knows the ultimate target information systems but also how to get there every step of the way seamlessly, similar to autonomous cars taking to destination, except in this case, information systems that run your business.

### FIELD OF INVENTION

Embodiment of the present invention generally relate to autonomously/semi-autonomously transforming existing customer's business system based on COTS (e.g. SAP)) into a suite of self-generating, iterative, Cognitive Intelligent Automation target system which is best-in-class information system for the company within their industry for their software environment of operating system, database, supporting Artificial intelligence, Robotics Process Automation, Deep Learning using Customized Neural Networks and Machine-to-Machine learning, Internet of Things, Blockchain, In-Memory computing, Big Data Analytics, image and speech recognition, while also providing what-if actionable Business Intelligence reports, checklists & roadmaps, to top management against both the proposed and existing business system.

### BACKGROUND OF INVENTION

Many businesses have the same need from their existing operational business system for business intelligence strategic, tactical, operational to ensure long-term profitability of business running on the latest versions supporting AI, Cognitive, IoT, full automation offered by COTS vendor; often they can only do piece-meal transformation/implementation business information system to the latest versions and not comprehensive one. Master CIATSFABI transforms Customer's existing business system to the best-in-class business system within the industry and company for operational excellence, taking advantage of latest technology, version offered by vendor and iteratively designs and prototypes ultimate transformed target system (Customer's CIATSFABI), while providing what-if actionable Business Intelligence reports, checklists & roadmaps, to top management against both the proposed and existing information system.

Comprehensive transformation by. Master CIATSFABI creates reference best-in-class SAP latest version supported for the company's industry by COTS vendor, using Best practices configuration database, sample Master and transaction data, will be called IndustryRef CIATSFABI.

Master CIATSFABI references IndustryRef CIATSFABI in transforming Customer's existing business system to the best-in-class business system within the industry and company for operational excellence, taking advantage of latest technology, version offered by vendor and iteratively designs and prototypes ultimate transformed target system (Customer's CIATSFABI), while providing what-if actionable Business Intelligence reports, checklists & roadmaps, to top management against both the proposed and existing information system.

In addition, CIATSFABI will be quick to react to external/internal events, emerging technologies, 24×7, for Strength, Weakness, Opportunity and Threats (SWOT) and provide appropriate advice real-time to top management including reports, checklists & roadmaps to thwart competitors/new entrants in the extreme nature of competitive world.

Many of the existing enterprise systems are mainly operational systems with some limited analytics and the business intelligence is not all pervasive and the systems rarely provide checklists & roadmaps to C level executives and BOD, as suggested in Customer's CIATSFABI aka Target System. Also, these systems lack automation of business process to the fullest potential as suggested in Customers CIATSFABI.

In the extreme nature of competitive world with established companies run over by new entrants, companies are slow to react to emerging technologies threatening their very own existence, because they don't have 24-hour intelligent Cognitive Intelligent Automation systems that constantly look for opportunity and threats and provide appropriate advice in real-time. Finally, even with advancement in AI technologies, cloud computing, in-memory technologies, SAP Leonardo, Big Data and Analytics, Natural language processing (NLP), Speech and image recognition, Internet of Things, there is no concept, idea or system available till date that can autonomously/semi-autonomously transform existing system with self-curing and/or fine tuning measures to provide target best-in-class system while providing Business Intelligence reports, checklists & roadmaps, to top management against both the proposed and existing information system, to assist real-time the management in the strategic, operational and tactical decision making.

Rationale on Dire Needs for this Invention

Research done so far is not super practical for many companies to let a third-party system decides on the transformation of their core business information system to the latest versions and hence it is hoped this innovative system will encourage every organization's business information system to transform autonomously/semi-autonomously and elevate to the highest-level of intelligent information system that is best-in-class in the industry/company converting all existing data including configuration, master, transaction, historical data and features of current system, converting data where needed, to work with this target version. The target system (Customer's CIATSFABI with have inbuilt governance mechanism to remain best-in-class system real-time, while providing Business Intelligence reports, checklists & roadmaps, to top management against both the proposed and existing information system based on COTS applications (e.g., SAP, Oracle). These COTS applications have been used by companies belonging to different industries (e.g., Chevron in Oil & Gas, Merck in Pharma) by customizing the generic packages to suit their unique business process needs using customizing, spanning many functional areas from Sales, Purchasing, Supply Chain, Customer Relationship management, Financial accounting, Analytics and many others. Many of the COTS applications implement project-wise customizing where one or more of functional areas (Sales, Purchasing, Supply Chain, Customer Relationship management, Financial accounting, Analytics) or Big-Bang approach where all areas are implemented company-wide in one go.

The Customer's CIATSFABI transforms autonomously/semi-autonomously core information system of any company belonging to any industry, to the latest available versions provided by package vendor (e.g., SAP/Oracle) without losing their investments in the customized existing system including configuration, master, transaction, historical data and features of current system, converting data where needed. CIATSFABI aims to autonomously/semi-autonomously transform existing COTS business systems of diverse companies/industries by preserving and upgrading converting all existing configuration, master, transaction, historical data and features of current system, converting data where needed, to work with this latest target version. Huge untapped market opportunities to address business intelligence, automation needs incorporating latest technologies such as Artificial intelligence, Robotics Process Automation, Deep Learning using Customized Neural Networks and Machine-to-Machine learning, Internet of Things, Biockchain, In-Memory computing, Big Data Analytics, image and speech recognition available from COTS vendor.

Alignment and support of transformed target version (Customer's CIATSFABI) with corporate mission, goals & objectives of the customers.

Current system is too transaction oriented and as they lack the artificial intelligence and cognitive intelligence platform, don't take advantage of Strength, Weakness, Opportunities and Threats (SWOT) due to internal/external events to take organizations to the next 10 to 50 years; Master CIATSFABI will autonomously/semi-autonomously transform existing system to the latest and best-in-class system available from system vendors (target version aka Customer's CIATSFABI) while providing guidance and actionable intelligence in real-time considering internal and external events.

### BRIEF SUMMARY OF INVENTION

Cognitive Intelligent Autonomous Transformation System (CIATSFABI) which transform any customer systems running standard COTS (Commercial off the shelf System) package (e.g. SAP to start with and other 3^{rd} party COTS (e.g. Oracle etc.) in the future) to provide a set of cognitive intelligent automation systems (Master (transformation system), Customer (Target) and IndustryRef (Latest version supported for that Industry by the COTS Vendor and used as Reference System)) that works with existing customer package versions etc. (e.g. SAP ECC 6 Enhancement pk 4, BW, CRM, Hybris 5.x, Oil & Gas Industry solution etc.) and suggest the best and most used, fully supported for the industry (e.g. Oil & Gas), and latest version for their future system (e.g. SAP S4HANA 1805 Oil & Gas IS, with BW/4HANA, Hybris 6.6 etc.).

### Target System can be One of the Following Three Scenarios:

Brown-Field or System conversion from existing to IndustryRef version, provided upgrade path is possible as confirmed by using the following tools (e.g., SAP S/4 HANA, SUM2.0)
a. Transformation Navigator, a self-service tool that analyzes current landscape to chart digital path to an intelligent enterprise.
b. Readiness-Check that delivers simplified technical guidance on readiness to move forward with system conversion
c. Maintenance Planner enables easy planning of all changes to the system landscape
d. Roadmap viewer that provides general or solution specific implementation roadmaps
e. Simplification item catalog that lists inconsistencies in functionality between different target versions
f. Prerequisite Check that identifies issues before even performing actual system conversion (e.g., SAP SUM2.0)
g. Custom Program test cockpit that runs static test and unit test on custom programs for compatibility with the target version and what additional steps need to be taken to mitigate the issues found (e.g., SAP ABAP test cockpit)
Global Landscape Transformation
Consolidation of several regional business systems into a single Global system or selective data migration based on legal entities
Green-field or New Implementation when not possible to do system conversion
a. Retire old land-scape and
b. implement innovative business processes with best-practice on a new platform
   SAP Leonardo Platform Predefined scenarios AI Chatbot, RPA and AI ML

A. Master CIATSFABI using SAP Leonardo Conversational AI/Chatbot
Build Skills Faster
   End-to-end bot building collaborative platform with intuitive user experience (UX)
   Data augmentation speed up bot training
   FAQ Document to Skills
   Natural Language Generation (NLG): Macro functions in bot replies
   OData (open data protocol) skills generation (OData service connection, Create, Read, Update, Query (CRUQ) & mandatory parameters only)
   Bot Builder v3: New “atomic & granular” dialog engine
   NLG: Automatic suggestion of bot replies
   Private gallery to re-use content
   Full OData skills generation
   Advanced dialog interactions & New design time
   Representational State Transfer (REST) skills generation
   Q&A: Unstructured documents to skills
Powerful Do the right thing
   World-class Natural Language Processing (NLP) and NLP API
   New classification algorithm
   Hub: Simple dispatch strategy between multiple bots
   Powerful entity detection (Multi label detection (cross Named Entity Recognition (NER)) & Disambiguation, Dynamic entry values fetching)
   Edge cases strategy (no-match, multiple matches): webhook, ML, rules . . .
   Remote NER
   ML & context-based dispatch
   Action Filtering: Triggers & requirements validation by external system
   Restricted Entity values disambiguation
Insightful
   Context Management: move from sentence to conversation-based bots
   Versioning management
   Conversation logs
   Emotion detection
   Live train tips
   New intents from log feed
Integrated
   Seamless integration with SAP products
   Automated customer service solutions by industry (available for Telco, banking, insurance, utilities)
   SAP user experience aka Fiori Webchat connected to any bot-UI messages alignments
   OData Middleware: transform odatato http requests
   Webhook response mapping:
      map webhook result to message type
      use code to create dynamic messages
Secure & Enterprise Grade
   Enterprise developers account: Identity Provider (IDP) support for bot developers
   Automatic bot testing: Introduce configurable unit tests for bot
   Multi tenancy
   Single-Sign-On (SSO): End user authentication (from the webchat to the final http request, with IDP implementation)
   Bot delivery
   Deliver same bot to multiple customers
   Dataset is customizable by customer
DA: Easy Setup
   SAP FIORI 3.0 visualization adoption
   Simple Digital Assistant landscape setup: Health check & simplified configuration
   Main config view
      a Skills activation, Product version configuration
B. Master CIATSFABI using SAP Leonardo Intelligent Robotic Process Automation (RPA) 2.0
   Deliver core framework for Intelligent RPA
   Integrate desktop automation scenarios
   Identify S/4HANA automation scenarios
   Provide connectors for desktop tools, MS office, third-party systems, web applications
   Enhance bot building through process recording
   Integrate cloud runtime for Intelligent RPA
   Integrate Conversational AI and Machine Learning
   Identify SuccessFactors automation scenarios
   Expand bot creation and runtime environment to deepen integration with SAP Line-of-Business (LoB) products
   Introduce marketplace for out-of-the-box industry best practices
   Handle unstructured data for end-to-end automation
   Identify pre-built content for wider SAP portfolio
   Provide further recording and integration capabilities to cover entire SAP technology portfolio
   Conduct PoC for Process Mining/Process Visibility
   Improve bot stability using Computer Vision
   Introduce machine learning-based bots for exception handling
   Integrate with SAP Cloud Platform Workflow Service (SAP Business Process Management (BPM)
C. Master CIATSFABI using SAP Leonardo Machine Learning (ML) Platform
   Leonardo Machine Learning Foundation and SAP Data Hub available as separate products for machine learning development
Development Platform
   End-2-end development process from data delivery to ML model creation/training/consumption
   Built-in notebook & graphical pipelining environment
   Governance & meta data catalog
   Predefined connectivity, and data preparation/profiling tools
   Specific lifecycle management for ML Scenarios
   Model training & inference with metrics collection, debriefing Inc. Consumption reporting
   Available as managed cloud service with consumption-based pricing via SAP CP (AWS)
   Automated labeling & annotations of data assets
   Data Lineage and data usage capabilities
   Pre-packaged libraries/content and open extensibility & SDKs
   Operations Dashboard to monitor productive execution
   Enhanced multi-tenancy capabilities including metering
   Deeper integration & connectivity into SAP Enterprise applications like S/4HANA, C/4HANA
   Support for additional hyper-scalers and on-premise deployments with SAP Data Hub
   Out-of-the-box ML scenarios automated via Data Pipelines
   Versioning of ML data sets
   Predefined content for e2e business processes
   Delivery of intelligent data applications
   Automated anonymization and verification according GDPR requirements
   Self-learning metadata management
   Semantical data extraction for SAP systems (e.g., SAP S/4HANA, SAP ECC)
Business Services
   Document Information Extraction
   Employee Matching
   Line-Item Extraction
   Vendor Matching
   Further scenarios for Business and Functional services
Functional Services: readily consumable pre-trained models
   Time series change point detection
   Similarity scoring
   Image classification
   Customizable image classification
   Image feature extraction
   Further scenarios for Business and Functional services
D. Master CIATSFABI using SAP Leonardo AI-Machine Learning scenarios across enterprise to improve customer experience
   Marketing:
      Personalization (Product recommendation, Offer recommendation),
      Intelligent scores (Channel optimization, campaign optimization, contract engagement score, Account engagement score)
      Sentiment engagement score (Sentiment analysis on product reviews,
      Customer behavior (buying propensity, New customer acquisition, Automated sales discount to customers that are entitled, Lead conversion propensity, Reduced customer churn rate improving customer retention)
      Customer Journey Insight
   Commerce:
      Personalized Customer Experiences
      Contextual merchandizing
      Context driven services
      Enterprise AI Chatbot
   Service
      Ticket Intelligence (Self-service digital interface, single level ticket categorization, similar tickets, ticket routing completion, spam classifier, Jam article recommendations, ticket classification and entity extraction NLP, Estimated time for completion)
      Contextual merchandizing
      Context driven services
      Enterprise AI Chatbot
      Solution Intelligence (email Template recommandation, reponse recommandation, KB Article recommandation)
      Virtual assistant answer Bot
      Field Service Intelligence (Service & Parts recommandation)
   Sales
      Imaging intelligence
      Sales Automation (Opportunity scoring, Lead scoring, Account insights)
      Commissions (incentive optimizations, Intelligent Coaching, Sales capacity planning)
      Configure Price to Quote (Price optimization, Up-Sell, Cross-sell recommendations, Configuration recommendations)
      Intelligence sales (Relationship Intelligence, Deal intelligence, Pipeline management, Predictive forecasting
E. Master CIATSFABI using SAP Leonardo AI-Machine Learning scenarios across enterprise for the Digital Core
   Finance
      Cash Application (AR Line-item matching, AP Line-item matching, Payment advice extraction, Lockbox line-item matching)
      SAP Tax compliance
      SAP Business Integrity screening,
      Account reconciliation
      SAP real spends
      SAP Financial statement insights
      Detect Abnormal Liquidity Item
      Intelligent Accrual recommendation
      Cash Application for FICA
      Natural Language Processing: (Manage Bank statements, display correspondence history, monitor payments, manage supplier line items, manage payment advices, process receivables, manage cost centers, approve bank statements, doubtful account validation)
   Sales
      Sales quotation
      Sales performance
      Delivery performance
      Natural Language Processing: (manage sales contracts, manage sales orders, manage sales quotations, track sales orders, manage credit memo request, manage debit memo request, manage sales order without charge)
   Procure
      Quantity Contact Consumption
      Cash Discount at Risk
      Creation of New Catalog Item
      Propose Material Group
      Reduce Off Contract Spend
      Predict Delivery Date for Purchase Order
      Image-based Ordering
      Intelligent Approval Workflow
      Natural Language Processing: (Smart Buying)
   Project
      Project Cost Forecasting
      Digital Content Processing
      Natural Language Processing:(Manage Projects)
      Variant Configuration analytics for configuration data Top Seller Produce
      Stock in Transit
      Demand-Driven Replenishment
      Defect Code Proposal (incl. Text Recognition)
      Early detections of slow and nonmoving stocks
   Master Data Management
      Business Rule Mining
      Smart Default Values
   SCP Enablement
      Automatic Floor Plan Extraction
      Automated Email and Service Request Category mapping
      Configuration optimization based on load in Convergent Charging
   Digital Support Experience with Natural Language Processing
      Create Feature Request
      Create Support Incidents
      Contact Key User
      SAP User (S-User) Management
      Advanced Search
      Show My Support Incidents
   Transport Management with Natural Language Processing (Manage Freight Agreement)
F. Master CIATSFABI using SAP Leonardo AI-Machine Learning scenarios across enterprise for the Manufacturing and Supply chain
   Intelligent Asset Management
      Predictive Maintenance & Service (Machine Failure Prediction, Unnormal Machine State Detection, Failure Mode Analytics, Extensibility of ML Engine through custom algorithms Life Indicator Forecasting, Leading Indicator Analytics, Fingerprint Analytics using anomaly detection, Configuration Correlation Analysis)
      Asset Manager (Measure recognition and equipment recognition via object detection)
      Asset Strategy and Performance Management (Cost-sensitive Asset Maintenance Strategy optimization)
      Plant Maintenance (PM)/Execution (Failure Mode Suggestion for Workorders/Notifications, Intelligent Work order ranking, Notification/Alert deduplication based on ML-techniques)
      SAP Newton (Predictive Engineering Insights, Frequency diagnostics for rotating equipment)
   Digital Manufacturing
      Predictive Quality Management (Extending Defect Detection with machine data, Golden Batch-Anomaly detection)
      Resource Orchestration (Auto Dispatch-Preload Resource allocation Enhanced with User Interface)
   Resource Orchestration
      Auto Dispatch—Preload Resource allocation
   Supply Chain Management & Logistics
      Integrated Business Planning (Anomaly detection in Batch Jobs, New Product Introduction, Decision Support for Alert Handling, job scheduling optimization, Anomalies Detection in Master Data, Forecast Level Optimization, Natural Language Processing via AI Chatbot
      Extended Warehouse Management (EWM) (Intelligent Fixed Bin Strategy)
      Warehouse Insights (WI)(Warehouse Shift Planning including What-if analysis, Maximum Working Capability Analysis for Resource Type, Intelligent Optimization Settings for Warehouses)
      Transportation Management (TM)(Automatic Transit Time Adjustment, Real Cost Tour Planning, Intelligent Transportation Cockpit)
G. Master CIATSFABI using SAP Leonardo AI-Machine Learning scenarios across enterprise for Industry Specific Solutions
   Retail
      Cloud Sales Transaction Serv
         Point-of-Sale (POS) Data Transfer and Audit
      164 ICD CI SCDP Store Replenishment
         Cost Optimal Ordering
      Allocation Management: Cross-product allocation
      Merchandising Mgt.-ML integration to Global Data Synchronization
      SAP Customer Activity Repository (CAR)
         Assortment Planning—Optimization
         Assortment Planning—Pre-pack optimization
         Assortment Planning Store Clustering
         Product Similarity Scoring
         Unified Demand Forecast
         Forecast based Promotion Mgt.
         Promotion Management Affinity Analysis
         Assortment Planning Decision Support
Consumer Products
   Demand Signal Mgt. Data Quality Service
Telco
   SAP Big Data Margin Assurance
      Customer Profitability Analytics
High Tech
   SAP Sourcing Simulation and Optimization (Intelligent Negotiation Engine)
IM&C
   SAP Product Configuration Intelligence
      Popularity of option (API SCP Service)
      Intelligent Product Selection Engine
   SAP Project Manufacturing Management and Optimization
      Intelligent Cross Project Parts Exchange
Utilities
   Cloud for Energy Smart Meter Data Analytics in Utilities
   Customer Profitability Analytics in Utilities
   SAP S/4HANA IS Utilities
      Implausible Meter Readings
      Outsortedbilling documents
Professional Services
   Copilot Project Managers and Consultants Skill
High Tech
   SAP Sourcing Simulation and Optimization
      Multi Period Quoting
Banking
   SAP S/4HANA Tailormade offers for loan roll-over contracts
   SAP S/4HANA TRBK 1.0
      Automated post-processing of loan payments—Intelligent Account Finder
Automotive
   JIT Call Validation (SAP S/4HANA Cloud for Discrete Manufacturing)
Public Sector
   Behavioral Insights OD 1.0
      Tax Services with ML
         Autonomous Transformation of Customer's COTS (e.g., SAP) Business System High-Level AI Machine Learning with TensorFlow Keras deployment—Overview

### Use Cases:

1. Provide assistance to sales team when customer enquiries about an industrial part including show him image for the part or variants (similar images) by the sales inquiry screen or through chat window (using AI Chatbot (NCP))
2. Provide assistance to service parts ordering by showing the industrial part image to the technician servicing industrial machinery in the workshop.
   The above requires image classification model of say 60000 industrial parts with 10 different classes and the following describes the procedure to develop custom TensorFlow 2.0/Keras model, train the model and deploy in production in cloud foundry so the SAP Leonardo can provide appropriate user experience to utilize the AI trained image classification model.

### Master CIATSFABI (Transformation System) Uses Either

1. Pre-built AI-ML scenarios with pre-trained model to provide unique AI based solutions across the enterprise on most of the business areas on major industry solutions as indicated in D, E, F, G or
2. Use custom TensorFlow 2.0/Keras model with custom training data and save trained model; the trained model is then uploaded to SAP Leonardo's ML foundation platform to provide custom AI based solutions across enterprise for many industry solutions. (Please see FIG. 9 for more details)
Use cases:
   1. Provide assistance to sales team when customer enquiries about an industrial part including show him image for the part or variants (similar images) by the sales inquiry screen or through chat window (using AI Chatbot (NCP))
   2. Provide assistance to service parts ordering by showing the industrial part image to the technician servicing industrial machinery in the workshop.
      The above requires image classification model of say 60000 industrial parts with 10 different classes and the following describes the procedure to develop custom TensorFlow 2.0/Keras model, train the model and deploy in production in cloud foundry so the SAP Leonardo can provide appropriate user experience to utilize the AI trained image classification model.

### Customer's CIATSFABI (Proposed) Will be Realized Using the Following Phases—Overview (Please See FIG. 1):

A. Autonomous/Semi-Autonomous Pre-Discovery Phase where the Master CIATSFABI interaction with customer's existing system generates IndustryRef CIATSFABI, Digital Assistants, Possible Automation Scenarios such as RPA and AI scenarios (vendor supported with pre-fed training data and custom scenarios using Keras, TensorFlow 2.0 with customer's own training data.)
B. Autonomous/Semi-Autonomous Discovery Phase where Master CIATSFABI interaction with customer's existing system and IndustryRef generates in-depth understanding of the goals, scope, and limitations. Possible fine-tuning of Automation Scenarios such as RPA and AI scenarios (vendor supported with pre-fed training data and custom scenarios using Keras, TensorFlov, 2.0 with customer's own training data.)
C. Autonomous/Semi-Autonomous Analysis Phase where further business intelligence and automation opportunities from outputs from Pre-Discovery and Discovery phases to decide in implementation of target system (a. Green-Field or New Implementation or b. Brown-Field or Systems Conversion or c. Global Consolidation of Regional systems). Possible fine-tuning of Automation Scenarios such as RPA and AI scenarios (vendor supported with pre-fed training data and custom scenarios using Keras, TensorFlow 2.0 with customer's own training data.)

### Customer's CIATSFABI (Actual) by IT Team (Following Guidelines, Checklist and Reports Produced in the Earner Phases) Will be Realized Using the Following Phases (Please See FIG. 1):

D. Semi-autonomous Pre-Implementation Phase where the Master CIATSFABI interaction with customer's existing system, IndustryRef CIATSFABI to generates various checklist, roadmaps, guidelines for IT/infrastructure team, Business users, management of the possible Target system Customer's CIATSFABI which will be used by IT team to prepare the landscape of target system Customer's CIATSFABI including conversion of Configuration Data, Master Data, Transaction Data.
E. Semi-autonomous Implementation Phase where the Target system Customer's CIATSFABI will be created as one of New Implementation or Systems Conversion or consolidation of several regional systems to one Global Instance, entirely by IT team, management, Business users strictly following their IT standards, change management procedure and following the recommendations provided in the earner phases. The Data conversion (Configuration Data, Master Data, Transaction Data, Historical Data) will also be done in this phase so Cutover activities can begin on the target version.
F. Semi-autonomous Post-Implementation Phase where the Target system Customer's CIATSFABI will be on support mode solving any critical issues that came up after the transformation to target version. Very strict configuration control and change management procedure will be in place and the transformation team management will be kept in loop as well as identifying potential areas for improvement. The Customer's CIATSFABI will be synchronized with Master CIATSFABI so the Transformation system has the latest updated configuration RPA, AI scenarios in its database.
G. Autonomous/Semi-Autonomous Continuous Improvement Phase where the existing system (Customer's CIATSFABI will be constantly interacting with Master CIATSFABI and strive to keep the current system current and relevant by looking at the next version(s) released by vendor and see if transformation to the new version is warranted as per customer and if so, the whole cycle repeats, Customer's CIATSFABI (proposed) will be realized using the following phases—Details (Please see FIG. 1):

### Pre-Discovery, Discovery, Analysis Phase

CIATSFABI autonomously/semi-autonomously transforms current COTS system to the latest recommended version supported by vendor for the industry and company while protecting configuration, master, transaction, historical data and features of current system, converting data where needed.
Master CIATSFABI system hosted in cloud, transforms customer's existing COTS system (e.g., SAP) to transformed target system aka Customer CIATSFABI which can be hosted in either cloud or in their premise if possible. Master CIASFAB, produces transformation of popular COTS for all major industries world-wide and CIATSFABI rolls out a to Customer's IT semi-autonomously once customer approves target version so they can prepare target landscape and use vendor supplied upgrade tools to transform (e.g., SAP SUM 2.0) along with all the data (Configuration, Master, Transaction and Historical data).
Master CIATSFABI generates checklists, roadmaps, Alerts incl. SWOT analysis reports on current customer's business system and proposed Customer's CIATSFABI to top management, to assist top management's interest and approval to implement target system.

### CIATSFABI Intelligent Enterprise Architecture

CIATSFABI (Master CIATSFABI will be based on SAP Leonardo Artificial intelligence platform and Customer's CIATSFABI (to begin with also on SAP Leonardo platform) which supports Artificial intelligence (AI), Robotic Process Automation (RPA), Internet of Things (IoT), Machine Learning (ML), Natural language processing (NLP), Speech and image recognition, Deep Learning (DL) using neural networks (NN), In-memory computing and block-chain.
CIATSFABI will Support core industry specific implementations (Consumer Industries (Consumer Products, Life Sciences, Retail, Fashion, Apparel Footwear Solutions, Wholesale products), Financial Services (Banking and Insurance), Energy (Oil & Gas, Chemicals, Utilities), Service Industries (Professional Services, Telecom, Media, Cargo Logistics, Engineering construction) Discrete Industries (Industrial machinery & components, Aerospace & Defense, Hitech, Automotive) with accelerated AI solutions; CIATSFABI will be customized for each customer (Customer's CIATSFABI) and installed on-premise or cloud.
CIATSFABI produces actionable Business Intelligence reports, checklists & roadmaps, against the proposed system (Customer's CIATSFABI) and existing system including reports on gaps in the current initiatives on existing system and potential initiatives on proposed target system.
Master CIATSFABI with also assist in the rollout for company including multi-national company's business system (eCommerce, ERP, CRM, BW.) to the ultimate version of the system (or lower versions if customer desires aka Customer's CIATSFABI).

### CIATSFABI's Data Preparation Module to Feed to AI Based CIATSFABI Model.

CIATSFABI's data preparation module reads configuration settings data from the configuration database (aka Implementation Guide (IMG)) initially using SAP ABAP programs to excel format and use it in python program with TensorFlow 2.0 and Keras along with industry specific settings, company specific settings, custom modules and pre-processes and handles all use-cases including exceptions to parse and convert the customer data including configuration data, master data, transaction data and historical data and provide guidelines and roadmap to IT team to transform existing system to transformed target system (Customer's CIATSFABI). IT team will use specialized tools to prepare the target landscape and migrate data using data workbench (DWB) and/or migration cockpit.
CIATSFABI propose the best and most used, fully supported Customer's CIATSFABI for the industry (e.g., Oil & Gas industry for Chevron, Merck for Pharma), and latest version for their future system (e.g., SAP S4HANA 2020 Oil & Gas IS, with SAP Business Warehouse on S4HANA aka BW/4HANA platform, SAP eCommerce with Hybris 2020.).
CIATSFABI analyze existing system for automation opportunities for core business processes enabled based on the best practices of other companies in the same industry or even across industries. CIATSFABI identify infrastructure & security vulnerabilities and seek potential for improvements in the transformed target system.
CIATSFABI enable new business processes, solution extensions, and/or other software that can be enabled based on the best practices of other companies in the same industry or even across industries.
CIASFAB identifies capability maturity ranking real-time, identifying the gaps in their initiatives on existing system against potential initiatives on target system.

### CIATSFABI Model Structure:

Master CIATSFABI an SAP Leonardo platform combines artificial intelligence including robotic process automation for program-based transformation automation and cognitive computing through data-driven predictive transformation automation scenarios including exception handling, in a single operating environment using the same sets of data transforming existing customer system to a self-evolving cognitive intelligent automation target system Customer's CIATSFABI (proposed) with guidelines, checklists, reports and hand them over to IT team who will do the transformation to Customer's CIATSFABI (actual) using vendor supplied tools (e.g. SAP SUM 2.0, Migration Data workbench) while following the guidelines, checklists, reports supplied by Master CIATSFABI
Master CIATSFABI uses the parsed data from existing system, transforms existing system and data, converting where needed, by feeding into the CIATSFABI's AI model in series of iterations—starting with initial first-cut Basic transformation based on customer selection of Quick win and best-in-class Advanced transformation based on customer selection of complexity desired—moderate or complex or futuristic.
CIASFAB, validates license purchased by customer and decides all privileges of transformations available in transformed target system.
Master CIATSFABI eventually transforms existing customer's business system to Customer's CIATSFABI (proposed), the recommended version supported for the industry and company by providing guidelines, reports and checklists to IT team who will use vendor supplied tools (SAP SUM 2.0, Migration Data workbench) to create the target system landscape do the data conversion including configuration data, master data, transaction data and historical data of current system, convert custom programs and realize the target Customer's CIATSFABI (actual), following guidelines, reports and checklists generated by Master CIATSFABI.
CIASFAB transformed target system that supports and aligns with corporate mission, goals & objectives of the customer.

### Deep-Learning Using Neural Networks on CIATSFABI Model:

CIATSFABI transformed target system using Deep-Learning (Neural networks with dynamic number of nodes/layers, hidden layers supported by SAP Leonardo) with each iteration f by feeding in various mini-cognitive system starting with initial first-cut Basic transformation based on customer selection of Quick win and best-in-class Advanced transformation based on customer selection of complexity desired—moderate or complex or futuristic, with Unsupervised learning, supervised learning, Reinforcement Learning, to arrive at Customer's CIATSFABI (actual) with reports, guidelines, checklists to IT team so they can perform transformation using vendor supplied tools and the assistance provided by Master CIATSFABI.
Deep Learning with workflow-based exception handling that produces enhanced learning to the model.
Finally, Deep Learning improves Customer's CIATSFABI each time Master CIATSFABI is released every 3 months with better transformation of customer's business system.

### What-if-Analysis on Transformed Target System—Customer's CIATSFABI:

CIATSFABI produces actionable business intelligence and compliance reports for top management with checklists, roadmaps, Alerts incl. SWOT analysis for existing system & proposed system and also produce gap reports on existing initiatives on existing system vs. potential initiatives on target system.
The customer can choose this latest version or even lower version as transformed target company business system (Virtual_company aka Customer's CIATSFABI). CIATSFABI (proposed) and Master CIATSFABI provides rollout assistance for upgrade to Customer's CIATSFABI (actual) target system version and data, autonomously/semi-autonomously.
CIATSFABI also provides advice on strategy, tactical and operational execution on all business areas or lines of the business (LoB), while ensuring the corporate mission, culture, history and company image are well protected and augmented.
CIATSFABI aims to improve faster implementation, supported by system integrators, technology partners and global consulting partners. CIATSFABI ensures better alignment of corporate mission, goals and objectives with Customer's CIATSFABI target system.
CIATSFABI provides actionable business intelligence reports that include predicting from present to 1 or 2- or 5-years of new infrastructure needs, new products & services, new mergers & acquisition opportunities, predicting & mitigating emerging corporate vulnerabilities to board of directors, top management, business system users and stakeholders.
CIASFAB monitors both the internal events including company or organizational milestones, new product launches, new incentive programs, BoD/Shareholder meetings and significant external world events including impending political/economic/legal/tax rate changes global mergers & acquisitions, new technology innovation, producing Strength, weakness, opportunity, threats (SWOT) analysis reports that can significantly bring benefit to the customer company and its stakeholders.
Designing and Prototyping CIATSFABI system:
Master CIATSFABI fine-tunes transformation scenarios after interaction with proposed Customer's CIATSFABI starting with initial first-cut Basic transformation based on customer selection of Quick win and best-in-class Advanced transformation based on customer selection of complexity desired—moderate or complex or futuristic.
CIATSFABI interacts with customer using customer's inputs to iteratively design and prototype transformed target system, converting the existing system data where necessary, that works with this version.
CIATSFABI monitors progress of transformation of both the system and data, real-time.
Master CIATSFABI can be fine-tuned with Customer CIATSFABI to generate better business intelligence and automation system in the next iteration(s) of releases.
Master CIATSFABI can be fine-tuned with Customer CIATSFABI model, to improve transformation of current business system using predictive predetermined transformation business scenarios and exceptions.
AI/ML processing in Master CIATSFABI and Customer CIATSFABI:
The Master CIATSFABI will be hosted in the cloud and Customer's CIATSFABI either can be in cloud or on-premise if possible.
CIATSFABI system architecture based on SAP Leonardo supports Artificial intelligence (AI); Robotic Process Automation (RPA). Internet of Things (IoT), Machine Learning (ML), Natural language processing (NLP), Speech and image recognition, Deep Learning (DL) using neural networks (NN). In-memory computing.
The Architecture will allow AI/ML processing in cloud or IoT devices supported by SAP Leonardo or on the Edge system of SAP Leonardo. Customer's will have option to scale the AI/ML processing depending on the entitlement (based on License) and resources allocated are parameter driven including In-memory size, size of cloud instance, number of parallel processes and number of custom nodes in neural networks supporting Deep Learning.

### Execution and Rollout of Prototyped CIATSFABI System:

CIATSFABI s Initial Implementation of transformation of existing COTS based system will be on SAP platform initially with eCommerce, Enterprise Resource Planning, Customer Relationship Management and Analytics application areas and later other application areas of business with subsequent implementation other popular COTS platforms.
Customer's CIATSFABI starting with initial first-cut Basic transformation based on customer selection of Quick win and best-in-class Advanced transformation based on customer selection of complexity desired—moderate or complex or futuristic, is the proposed system which can be ldeal_virtual (latest version available on operating system, database from vendor) or one version lower which may be more stable and well-tested (virtual_company aka Customer's CIATSFABI).
CIATSFABI provides special rollout tools, technologies and methodologies for multi-national companies which usually the parent company controlling multiple companies operating in many countries, for smooth transformation of existing business system.
Custom tools, methodology and consulting assistance to partners, systems integrators and also customers will be provided to fine tune the proposed Cognitive intelligent automation system (i.e., virtual_company system), for the customer's unique enterprise system(s).
CIASFAB produces comprehensive step-by-step phased implementation checklist for IT, top management Project team and Business learns, to rollout customer's transformed target system

### Customer's CIATSFABI (Actual) Will be Realized by IT Team Using the Following Phases—Details (Please see FIG. 1):

Pre-Implementation, Implementation and Post-Implementation and continuous improvement Phase
CIATSFABI on customer's request, synchronizes and fine-tunes CIATSFABI based on finalized customer's transformed target system so better transformation of customer's system in subsequent iterations or release of CIATSFABI.
Feedback control mechanism will be provided to fine tune Master and Customer CIATSFABI, based on target version chosen along with all user inputs/choices.
All external events/system generating series of iterative cognitive system Basic, Advanced, Ideal virtual (target ideal system with latest version available for the industry and for company with platform specifics), Virtual_company (target company system which may be 1 or more versions older and more rugged and tested), each iteration of the customized system will provide superior intelligence than the previous system; if there are opportunities to upgrade the versions to the latest available and/or change from on-premise to cloud, such recommendations will also be provided.

To summarize, Master CIATSFABI system architecture supports Artificial intelligence (AI), Robotic Process Automation (RPA), Internet of Things (IoT), Machine Learning (ML), Natural language processing (NLP), Speech and image recognition, Deep Learning (DL) using neural networks (NN), In-memory computing, SAP Leonardo platform and different adapter modules, image and speech recognition & sensors, is a Cognitive Intelligent Autonomous Transformation System that transforms different company's enterprise information autonomously/semi-autonomously with the sole purpose of transforming existing customer's business system to the best-in-class AI based transformed target system while also providing actionable Business Intelligence reports, checklists & roadmaps, to top management, with minimal disruption to organization, processes and people.

### DETAILED DESCRIPTION OF INVENTION

Our Cognitive Intelligent Autonomous Transformation System (Master CIATSFABI Transformation system based on SAP Leonardo based on AI ML on RPA, NLP technologies installed on Cloud aka sidecar Transformation System) to interact with customer's systems to produce the ultimate Customer's CIATSFABI system in the following phases:
A. Autonomous/Semi-autonomous Pre-Discovery Phase where the Master CIATSFABI interaction with customer's existing system generates:
   1) IndustryRef CIATSFABI for the industry the company belong to, where best practice configuration data, sample transaction data, historical data will be used, will interact with existing Customer's system to generate initial set of digital assistants (advanced computer programs that use Artificial Intelligence (AI), Natural Language Processing (NLP), Machine Learning (ML) that simulate conversation with people over internet), possible automation scenarios such as RPA scenarios, AI Scenarios.
   2) Possible digital assistants such as Chatbots that will assist in conversing with key employees (Customer Support assistants, sales assistants, HR assistants) with various areas of business systems (e.g., SAP Conversational AI),
   3) Digital assistants are also able to access online information form the internet such as weather, stock prices, traffic conditions, schedules, news, schedule calendar events, manage emails, to do lists etc., and present the same in a clear, concise, and interesting manner to the user/system and can also act on voice inputs.
   4) Possible Automation using Robotic Process Automation (RPA) scenarios (Vendor supported with pre-fed training data and additional custom RPA scenarios with customer's training data) (e.g., SAP Intelligent RPA)
   5) Possible Automation using Artificial Intelligence (AI) scenarios (Vendor supported and additional custom AI scenarios) (e.g., SAP Intelligent AI scenarios with pre-fed training data and custom SAP AI scenarios using Keras, TensorFlow 2.0 with customer's own training data)
B. Autonomous/Semi-autonomous Discovery Phase where Master CIATSFABI interaction with customer's existing system and IndustryRef generates in-depth understanding of the goals, scope, and limitations:
   1) Scope of business intelligence and automation system needed in various areas will be identified in various phases.
      a. Series of Mini-Cognitive Intelligent Automation Adapters/Systems will provide Actionable Business intelligence reports, checklist, guidelines will be generated and can be fine-tuned and any corrections can be fed into (Master CIATSFABI) Cognitive solution setup, to generate better business intelligence in the next iteration(s).
      b. Also, various automation scenarios including RPA Bots, AI scenarios will be further identified and/or fine-tuned to provide full automation to the company's business systems.
      c. Proposes Customer's CIATSFABI as possible Customer's proposed target system.
C. Autonomous/Semi-autonomous Analysis Phase where further business intelligence and automation opportunities from outputs from Pre-Discovery and Discovery phases to decide in implementation of target system (a. Green-Field or New Implementation or b. Brown-Field or Systems Conversion or c. Global Consolidation of Regional systems)
   1) Finalized list of Business Intelligence and Automation opportunities using RPA scenarios and AI scenarios.
   2) Initial phase of implementation will be for eCommerce, ERP, CRM and Analytics.
   3) Additional phases covering other areas of business will also be implemented.
   4) For multi-national companies—special rollout methodologies will be provided.
   5) Finally, all external events affecting the company will be analyzed and advice will be provided from the Master CIATSFABI system to customer's CIATSFABI system, each iteration of the product will provide superior intelligence than the previous one.
   6) Our Cognitive Intelligent Autonomous Transformation System CIATSFABI (Master CIATSFABI) based on SAP Leonardo Platform, will utilize IndustryRef CIATSFABI and Customer's existing information system to transform it to target system aka Customer's CIATSFABI will all have the following characteristics
      SAP S4HANA, Leonardo based IoT environment:
      a. Internet of Things connects with people and makes infrastructure and market connect with everything.
      b. Big Data provides insights into the business.
      c. Machine Learning provide ways to use data for predicting outcomes.
      d. Analytics provides new processes and applications based on insights.
      e. Design Thinking help to innovate and offer the opportunity to excel
      f. Data intelligence provides trusted, real-time benchmarks and decision-making scenarios.
      g. Blockchain services provide trust in peer-to-peer transactions, full visibility of good provenance, increased audibility, and decreased fraud.
      cloud offering or On-premise where possible
      License purchased will determine the customer's CIATSFABI including all adapters, Digital Assistants and mini-cognitive systems.
      Custom tools, methodology and consulting to partners and customers will be provided to fine tune the CIATSFABI system, for the customer's unique enterprise system(s).
      Customizable Adapters to work with popular eCommerce (e.g., Hybris), ERP (e.g., SAP), BI, manufacturing systems, Big Data will be prototyped
      Leverage industry wide, inter-industry, intra company, intercompany business intelligence historically, the present and future initiatives
      A virtual (ideal) company with the necessary Business Intelligence reports, checklists, Roadmaps etc. will be generated by Master CIATSFABI and/or Customer's CIATSFABI and the gaps in the existing initiatives will be identified and actionable reports will be generated to assist in closing the gap.
      Feedback control mechanism will be provided by various Digital Assistants identified by Master CIATSFABI to fine tune the Cognitive Intelligent Automation systems, based on change in market place, laws, technology, etc. due to external events.
      Cognitive Intelligent Automation Solution Master and Customer CIATSFABI will cover wide areas—corporate vulnerabilities and cybersecurity risks, comprehensive audit, next generation of products and services, corporate governance for BOD, shareholders, employees etc., and various strategic, operational and tactical business intelligence for actions by employees, executives, BoD, Alignment of corporate mission, goals & objectives with suitable proposed information system solutions etc.
      The Cognitive Intelligent Autonomous Transformation System also is designed to understand the softer, cultural aspects of the company, the value proposition of their products & services, the emphasis provided by employees and management to handle the customer, suppliers and other stakeholders of the company, nurturing and promoting the values the company stands for.
      Target system can be one of the following three scenarios:
         a. Brown-Field or System conversion from existing to IndustryRef version, provided upgrade path is possible as confirmed by using the following tools (e.g., SAP S/4 HANA)
            1. Transformation Navigator, a self-service tool that analyzes current landscape to chart digital path to an intelligent enterprise.
            2. Readiness-Check that delivers simplified technical guidance on readiness to move forward with system conversion
            3. Maintenance Planner enables easy planning of all changes to the system landscape
            4. Roadmap viewer that provides general or solution specific implementation roadmaps
            5. Simplification item catalog that lists inconsistencies in functionality between different target versions
            6. Prerequisite Check that identifies issues before even performing actual system conversion (e.g., SAP SUM2.0)
            7. Custom Program test cockpit that runs static test and unit test on custom programs for compatibility with the target version and what additional steps need to be taken to mitigate the issues found (e.g., SAP ABAP test cockpit)
         b. Global Landscape Transformation
            1. Consolidation of several regional business systems into a single Global system or
            2. selective data migration based on legal entities
         c. Green-field or New Implementation when not possible to do system conversion
            1. implement innovative business processes with best-practice on a new platform
            2. Retire old land-scape and
D. Semi-autonomous Pre-Implementation Phase where the Master CIATSFABI interaction with customer's existing system, IndustryRef CIATSFABI to generates various checklist, roadmaps, guidelines for IT/infrastructure team, Business users, management of the possible Target system Customer's CIATSFABI which will be used by IT team to prepare the landscape of target system Customer's CIATSFABI including conversion of Configuration Data, Master Data, Transaction Data
   1) Finalized target version of Industry supported, as suggested by IndustryRef CIATSFABI
   2) Finalized checklist of things-to-do for IT/Infrastructure team
   3) Finalized roadmap to target system including any intermediate step of transformation such as Unicode, conversion of database to the target version database etc.
   4) Finalized guidelines for all teams—IT, Business, Management in the smooth transformation of Customer's existing system to Customer's CIATSFABI.
   5) Finalized list of custom programs that need to be converted prior to transformation to target version, as identified by Program Cockpit (e.g., SAP ABAP Cockpit)
   6) Formal hand-over to IT team so IT can prepare Project plan, change management, Cut-over planning activities, Data conversion (Configuration Data, Master Data, Transaction Data, Historical Data) to be compatible with target version.
E. Semi-autonomous Implementation Phase where the Target system Customer's CIATSFABI will be created as one of New Implementation or Systems Conversion or consolidation of several regional systems to one Global Instance, entirely by IT team, management, Business users strictly following their IT standards, change management procedure and following the recommendations provided in the earlier phases. The Data conversion (Configuration Data, Master Data, Transaction Data, Historical Data) will also be done in this phase so Cutover activities can begin on the target version.
F. Semi-autonomous Post-Implementation Phase where the Target system Customer's CIATSFABI will be on support mode solving any critical issues that came up after the transformation to target version. Very strict configuration control and change management procedure will be in place and the transformation team management will be kept in loop as well as identifying potential areas for improvement. The Customer's CIATSFABI will be synchronized with Master CIATSFABI so the Transformation system has the latest updated configuration, RPA, AI scenarios in its database.
G. Autonomous/Semi-autonomous Continuous Improvement Phase where the existing system (Customer's CIATSFABI will be constantly interacting with Master CIATSFABI and strive to keep the current system current and relevant by looking at the next version(s) released by vendor and see if transformation to the new version is warranted as per customer and if so, the whole cycle repeats.

Existing system will also be analyzed by
1. Digital Assistants that identify core business processes that have potential automation opportunities which are currently executed manually at enormous cost. Also checks how well the automation opportunity compares with best practices within same industry and across all industries.
2. Digital Assistants that identify Infrastructure vulnerability and potential for improvements
3. Digital Assistants that identify Security vulnerabilities including. cyber security threats
4. Digital Assistants that identify business process, and/or other software that might be enabled (which are not at present) based on the best practices of other companies in the same industry
5. Digital Assistants that identify percentage of maturity (Capability Maturity Ranking) real-time between IdealVirtual system and Existing information system software (e.g., SAP ECC enhancement pack 4, Hybris 5.5 etc.)
6. Customer may decide to upgrade to the recommended versions as suggested by IndustryRef CIATSFABI and if so appropriate roadmaps for upgrade to new system (called the Idealvirtual system) will be provided by Master CIATSFABI or can go lower versions.
7. The cognitive intelligent automation solution (CIATSFABI—Master, Customer and IndustryRef) will work with both upgraded system (target) and the existing version of the customer system.
8. Actionable business intelligence for all C level executives, Executive management and BOD providing checklists, roadmaps, Alerts incl. SWOT analysis
9. Compliance Reporting for BODs, C level executives, Divisional managers
10. Advice on strategy, tactical and operational execution on all areas/lines of the business (LoBs):—ecommerce, ERP, CRM, BW/BI, Product life cycle management (PLM), LoB, Products &Services, Infrastructure, corporate vulnerability while ensuring the corporate mission, culture, history and image are well protected and nourished with the assistance of the system from now on will be called CIATSFABI.
11. Actionable business intelligence products include but not limited to Predicting infrastructure needs from present to 1-2-5 years, new products & services, new M&A opportunities, Actionable strategic, operational intelligence, predicting & mitigating corporate vulnerabilities, corporate governance for BoD, employees, shareholders, identifying the gaps in their existing initiatives and approach and provide suitable reports to close the gap.
12. Initial phase of implementation will be for eCommerce, ERP, CRM and Analytics. Additional phases covering other areas of business will also be implemented
13. For multi-national companies—special rollout methodologies will be provided.
14. After few weeks of fine tuning of interaction with the systems, scope of business intelligence and automation system needed in various areas will be identified by appropriate digital assistants in various phases.
15. Series of Mini-Cognitive Intelligent Automation Adapters/Systems will provide Actionable Business intelligence reports, checklist, guidelines will be generated and can be fine-tuned and any corrections can be fed into Cognitive solution setup (Master CIATSFABI), to generate better business intelligence in the next iteration(s).
16. Also, various automation system including RPA BOTS will be generated to provide full automation to the company's business systems.
17. License purchased will determine the customer's CIATSFABI including all adapters and mini-cognitive systems.
18. Custom tools, methodology and consulting to partners and customers will be provided to fine tune the CIATSFABI system, for the customer's unique enterprise system(s).
19. Feedback control mechanism will be provided using digital assistants to fine tune the Cognitive Intelligent Automation systems, based on change in market place, laws, technology, etc. due to external events.
20. Finally, all external events affecting the company will be analyzed using digital assistants and advice will be provided from the Master CIATSFABI system to customer's CIATSFABI system, each iteration of the product will provide superior intelligence than the previous one.
21. Autonomous transformation of Customer's COTS (e.g., SAP) business system—High-Level AI—Machine Learning with TensorFlow Keras deployment—Overview (Please see FIG. 9 for more details). Master CIATSFABI (transformation system) uses either
   pre-built AI-ML scenarios with pre-trained model to provide unique AI based solutions across the enterprise on most of the business areas on major industry solutions as indicated in D, E, F, G or
   use custom TensorFlow 2.0/Keras model with custom training data and save trained model; the trained model is then uploaded to SAP Leonardo's ML foundation platform to provide custom AI based solutions across enterprise for many industry solutions.
Use cases:
   1. Provide assistance to sales team when customer enquiries about an industrial part including show him image for the part or variants (similar images) by the sales inquiry screen or through chat window (using AI Chatbot (NCP))
   2. Provide assistance to service parts ordering by showing the industrial part image to the technician servicing industrial machinery in the workshop.
The above requires image classification model of say 60000 industrial parts with 10 different classes and the following describes the procedure to develop custom TensorFlow 2.0/Keras model, train the model and deploy in production in cloud foundry so the SAP Leonardo can provide appropriate user experience to utilize the AI trained image classification model.
22. Autonomous transformation of Customer's COTS (e.g., SAP) business system—High-Level AI Chatbot/RPA (Please see FIG. 8 for more details)

To summarize, (CIATSFABI) is a set of cognitive intelligent automation systems (Master (transformation system), Customer (Target) and IndustryRef (Latest version supported for that Industry by the COTS Vendor and used as Reference System) that can be adapted to different company's enterprise information system architecture, amenable to learn further by neural networks/Deep Learning, AI, MU RPA Bots, In Memory computing technology (e.g. SAP S4HANA), IOT, Digital Assistants and different adapter & sensors with the sole purpose of providing actionable business intelligence reports, checklists, roadmaps to all C level executives, BoD and all executive management. Finally, Customer's CIATSFABI (Target System) will be made using SAP's S4HANA, SAP Leonardo (AI, IoT platform, IoT, MU RPA Bots, AI, Big Data Analytics together with m2m (machine-to-machine) and neural networks), to showcase the concept, product that will transform a typical say SAP based enterprise applications with a superior wisdom provided by this product for the entire enterprise using state-of-the-art Artificial intelligence using Deep Learning and Neural Networks and Cognitive Automation with MU RPA Bots.

### BRIEF SUMMARY OF DRAWINGS

FIG. 1—High level Transformation Process Overview comprises of Preliminary Discovery, Discovery, Analysis Adapter Module Analysis & Execution Phase and Pre-Implementation and Implementation, Post-Implementation and Continuous Improvement Phases.

FIG. 2—High level Architecture overview comprises of Preliminary Analysis Phase, Discovery Analysis Phase, Adapter Module Analysis & Execution Phase and Implementation Phase.

FIG. 3—High level Process Diagram comprises of Establish connectivity phase, Generate Cognitive system using Adapter module, Gap Analysis phase of actionable Business Intelligence reports, checklists & roadmaps, of Existing vs Proposed system, finalize target version phase, Governance Phase and update Master CIATSFABI phase.

FIG. 4—Detailed Process Diagram comprise of Prebuild analyzer phase with machine learning, RPA scripts to generate & fine-tune proposed Customer's CIATSFABI and Major scheduled release of Master CIATSFABI phase to regenerate customer's CIATSFABI.

FIG. 5 Create Virtual Build process with setup wizard has License validation phase, Discovery phase, and implementation phase in conjunction with Master CIATSFABI fine-tunes proposed Customer's CIATSFABI—Basic, Advanced, Ideal_virtual & virtual_company.

FIG. 6 Create Pre-Build ABG fine-tunes CIATSFABI with Prebuild process (FIG. 5) Quick win generates Company1_Alpha, Moderate complexity generates Company1_Beta, complex generates Company1_Gama and futuristic generates Ideal_virtual (Latest version). Finally, company1_ABG system interact with customer's system to fine-tune Ideal_virtual (Latest version), virtual_company (lower versions) and also support multi-national companies.

FIG. 7 Create Pre-Build ABG system exceptions with Deep Learning wizard fine tunes Master & Customer's CIATSFABI the Ideal_virtual and virtual_company, initially using predictive scenarios and later with exceptions which is further resolved by Deep Learning wizard providing better automation in future.

FIG. 8—Custom RPA Bot used in Master CIATSFABI (SAP Leonardo AI ML) Platform.

FIG. 9—Custom AI ML Scenarios using Python, TensorFlow, Keras used in Master CIATSFABI (SAP Leonardo AI ML) Platform, to build, train and deploy image classification model of say 60000 industrial parts with 10 different classes.

### DETAILED DESCRIPTION OF DRAWINGS

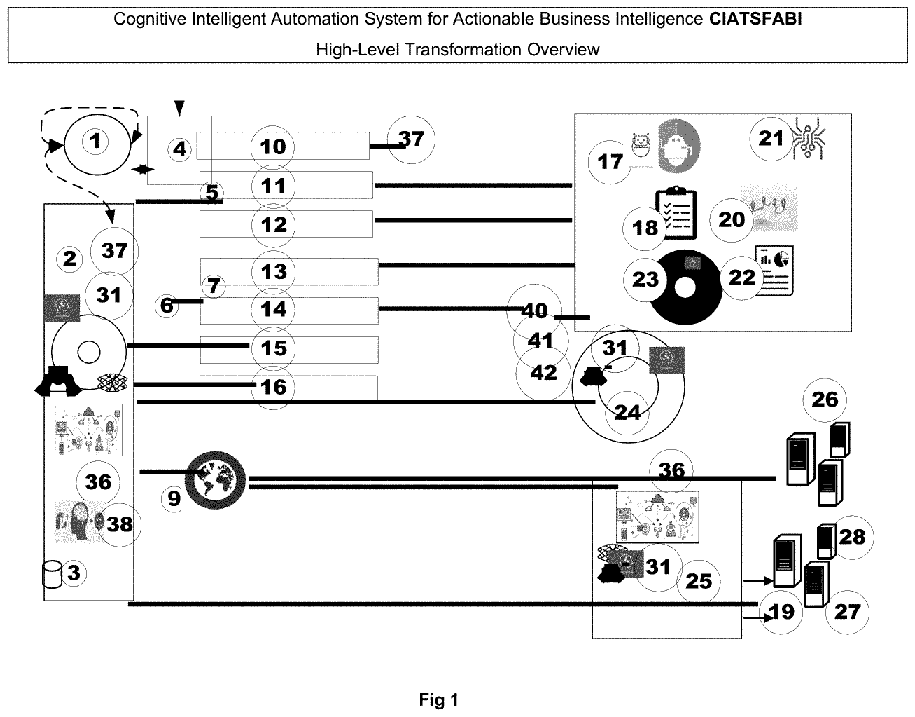

### FIG. 1—High Level Transformation Process Overview

| | |
|---|---|
| 1. | proposed Cognitive Intelligent Autonomous Transformation System |
| | Setup Wizard |
| 2. | Master Cognitive Intelligent Autonomous Transformation System |
| | for actionable Business intelligence (Master CIATSFABI) |
| 3. | Cognitive Super DB |
| 4. | Customer's Existing Information Systems |
| 5. | License |
| 6. | Connectivity Test |
| 7. | |
| 8. | |
| 9. | SWOT from External Events/Systems |
| 10. | Pre-discovery Phase |
| 11. | Discovery Phase |
| 12. | Analysis Phase |
| 13. | Pre-Implementation Phase |
| 14. | Implementation Phase |
| 15. | Post-Implementation Phase |
| 16. | Continuous Improvement Phase |
| 17. | Digital Assistants - AI Chabot, RPA Bot |
| 18. | Checklist |
| 19. | Virtual Company (Customer's CIATSFABI) |
| 20. | Roadmap |
| 21. | Digital Assistants - AI scenarios |
| 22. | Reports |
| 23. | Artificial intelligence based proposed Cognitive Intelligent |
| | Autonomous Transformation System Adapters |
| 24. | proposed Cognitive Intelligent Autonomous Transformation System |
| | (Basic) |
| 25. | proposed Cognitive Intelligent Autonomous Transformation System |
| | (Advanced) |
| 26. | Existing Enterprise Systems |
| 27. | Virtual company Enterprise Systems |
| 28. | Ideal Virtual Enterprise Systems proposed Cognitive intelligent |
| | automation solution/system |
| 29. | |
| 30. | |
| 31. | Artificial intelligence, Machine Learning, Deep Learning/Neural |
| | Networks, Robotic |
| 32. | |
| 33. | |
| 34. | |
| 35. | Quick wins |
| 36. | SAP Leonardo Intelligent enterprise platform |
| 37. | IndustryRef CIATSFABI |
| 38. | Digital Assistants |
| 39. | Implementation Approach |
| 40. | Brown-Field/System Conversion |
| 41. | Landscape transformation |
| 42. | Green-Field/New implementation |
| 43. | |
| 44. | |
| 45. | |
| 46. | Digital Assistants - Online Information |

FIG. 1—High level Transformation Process overview comprises of Preliminary Discovery, Discovery, Analysis Adapter Module Analysis & Execution Phase and Pre-Implementation and Implementation, Post-Implementation and Continuous Improvement Phases.

Summary of Overview (FIG. 1) has the following phases:

Pre-discovery (10) creates IndustryRef CIATSFABI (37)) with the latest version available for the industry the company belong to along with the best practice configuration data. IndustryRef CIATSFABI) works with Customer's existing system and identifies initial set of digital assistants (AI chatbot (17), RPA Bot (17), and AI scenarios (21), access online info from internet (46).
Preliminary Adapter Module (23) analyze overview of configuration of customer's business system for specific industry, company, region, country and size settings.
Adapter Module for detailed analysis of company settings for system (eCommerce, ERP, PLM, Mfg. Systems, CRM, Big Data and BW), Lines of Business (LOB), Products & Services, Infrastructure (Present & Future), Reporting (Present & Future).
Analyze existing customer's business system (4) (26).
Authenticate Licenses to ascertain privileges for customer's customized Cognitive AI based system.
Analyze all customer's business system (ERP, CRM, eCommerce, PLM, Manufacturing system, Bigdata, Analytics/BW).
Analyze industry specific and/or company specific implementation.

Discovery (11) phase provides goals, scopes, limitations for the eventual customer target system, generates adapters for reports, checklist roadmaps, automation scenarios Chatbot, RPA scenario, AI Scenario, finally propose customer target system
Master CIATSFABI (2) setup wizards in conjunction with IndustryRef CIATSFABI (37) produce opportunity matrix, solution enhancement to Ideal_virtual (latest version 28), chosen virtual_company system (can be one or more versions lower than the latest 27).
Produce platform specifics Prioritize solution based on user-inputs.
Automation analyzer Governance module ensures all Cognitive system are built correctly with referential integrity and also produces real-time percentage of completion.

Analysis (12) phase determines the appropriate transformation implementation—it can be one of green-field/new implementation or, Brown-field/System conversion or Global consolidation of several regional systems of multi-nationals. This phase also fine-tunes and finalizes Digital Assistants (RPA Bot (17), AI Chatbot (17), AI scenarios (21)). Initial implementation of transformation system will be for ERP, CRM and Analytics and other business systems later.
Analyze existing customer's business system (4) (26).
Authenticate Licenses to ascertain privileges for customer's customized Cognitive AI based system.
Analyze all customer's business system (ERP, CRM, eCommerce, PLM, Manufacturing system, Bigdata, Analytics/BW).
Analyze industry specific and/or company specific implementation.
Master CIATSFABI (2) setup wizards produce opportunity matrix, solution enhancement to Ideal_virtual (latest version 28), chosen virtual_company system (can be one or more versions lower than the latest 27).
Produce platform specifics.
Prioritize solution based on user-inputs.

All the above phases Pre-Discovery, Discovery, Analysis Phase (Autonomous/Semi-Autonomous) by Master CIATSFABI) (10, 11, 12) will be performed (Autonomously/Semi-Autonomously) by the Master CIATSFABI) to propose Customer's CIATSFABI) (proposed) and IT team takes over to prepare for Pre-Implementation, Implementation and Post-implementation Phases (13, 14, 15) to generate Customer's CIATSFABI) (Actual). Continuous improvement Phase (16) will look for opportunities to react to external/internal events, SWOT analysis and possible new version from vendors and the process repeats, possibly transforming to next version providing more competitive capabilities for the Customer—Customer's CIATSFABI (proposed next version)

To summarize the findings from above phase:
Pre-Discovery, Discovery, Analysis (10, 11, 12), phase results and SWOT analysis will be used by Master CIATSFABI (2) to produce Customer specific Cognitive System customers CIATSFABI system (Basic (24) (Quick wins)).
Upon further refinement of platform specifics and prioritizations produce Cognitive System (Advanced (25) (moderate complexity, complex, futuristic).
Existing customer's information system (4) licenses (5) are authenticated, before analyzing all their system (Enterprise Resource Planning, Business Warehouse/Business Intelligence, eCommerce, Big Data, Product Lifecycle Management, Manufacturing Systems) in any of the core industry specific implementations (Consumer Industries (Consumer Products, Life Sciences, Retail, Fashion, Apparel Footwear Solutions, Wholesale products), Financial Services (Banking and Insurance), Energy (Oil & Gas, Chemicals, Utilities), Service Industries (Professional Services, Telecom, Media, Cargo Logistics, Engineering construction) Discrete Industries (Industrial machinery & components, Aerospace & Defense, Hitech, Automotive) to come with a Basic version of cognitive intelligent automation proposed Cognitive Intelligent Autonomous Transformation System Basic, as directed by the Master proposed Cognitive Intelligent Autonomous Transformation System hosted in a datacenter. All of the customers system and datacenter system are tested for connectivity during wizard's Guided configuration. Further Discovery and implementation phases including SWOT (Strength, weakness, opportunity & Threats) analysis of internal/external events (9) improve the customer's cognitive information system to be proposed Cognitive Intelligent Autonomous Transformation System Advanced which is used to Create/finetune/update the Customer's CIATSFABI (19) which can be either ideal system (target Ideal_virtual system—ultimate Transformed target system 28) or Virtual company information system (Virtual_company Chosen Transformed target system 27) for the specific company.
The Cognitive Intelligent Autonomous Transformation System (Master CIATSFABI) (2) generates proposed Cognitive Intelligent Autonomous Transformation System (Customers CIATSFABI (19)), analyzes the existing information system (e.g., SAP system—Enterprise Resource Planning, Customer Relationship Management, BW, eCommerce.) with customer's intended ultimate platform (Ideal_virtual) and finds the best versions of the software as recommended by SAP through Product Availability Matrix. If an on-premise is desired by the customer but the best versions and features suiting customer's needs are only available in Cloud offering, the same will be recommended but the customer can still insist on only on-premise implementation with the understanding less optimal ultimate system will be available and that will be the company's transformed target system (virtual_company aka Customer's CIATSFABI).
The Master Cognitive Intelligent Autonomous Transformation System (Master CIATSFABI (2)) will use the Artificial intelligence repository (Cognitive Super DB (3)) using leading technologies—Machine Learning, Internet of Things, Block chain, Robotic Process Automation, In-memory computing, Deep Learning, Mobility and Artificial Intelligence Platform with the foundation architecture based on SAP Leonardo that provides Guided assistance (proposed Cognitive Intelligent Autonomous Transformation System setup Wizard (1)) (Configuration, testing, Proof of Concept, System-wide testing, Data Migration, Integration testing, cutover assistance and checklist for the implementation team for smooth implementation)
The proposed Cognitive Intelligent Autonomous Transformation System Solution is supported by Foundation Architecture—SAP Leonardo S4HANA (latest offering on Artificial intelligence and Enterprise Resource Planning platform from a vendor SAP) based Internet of Things and Artificial Intelligence environment, a combination of intelligent technologies, services, and industry solutions to provide innovative customized system for each customer.
All existing Enterprise information system (4) (26) for customer will be fitted with sensors and Internet of Things enabled, will be tested for Single-sign-on during connection test (6) with Master proposed Cognitive Intelligent Autonomous Transformation System (2), proposed Cognitive Intelligent Autonomous Transformation System Basic (24), proposed Cognitive Intelligent Autonomous Transformation System Advanced (25), Ideal_virtual (28), Virtual Company Enterprise Systems (27), to ensure that necessary configuration data, Master Data, Transaction data can be read and written with authorization as a proposed Cognitive Intelligent Autonomous Transformation System Superuser.
Proposed Cognitive Intelligent Autonomous Transformation System Setup Wizard (1), with Guidance from Artificial intelligence Master DB-Master proposed Cognitive Intelligent Autonomous Transformation System (2), after connection test (6) during Pre-Discovery, Discovery and Analysis Phase (10 11 12) will read from Existing information system (4) (26) will produce “identify Opportunity Matrix” which essentially identifies all solution advancement possible from current system to ultimate information system (28), Chosen Transformed target system-virtual_company (27). The Pre-Discovery, Discovery and Analysis Phase (10 11 12) also produces “platform specifics—reports and roadmaps” (22 20) which is also used in the possible solutions in the ultimate information system (28). Pre-Discovery, Discovery and Analysis Phase (10 11 12) also prioritize the solutions based on benefits with user's input and will be used in the possible solutions in the ultimate information system (28), Chosen Transformed target system-virtual_company (27).
Proposed Cognitive Intelligent Autonomous Transformation System Setup Wizard (1), with Guidance from Artificial intelligence Master DB-Master proposed Cognitive intelligent automation solution/system (2), after connection test (6) during Pre-Implementation and Implementation Phase (13 14) will use Pre-Discovery, Discovery and Analysis Phase results (10) (11) (12) along with SWOT (Strength, weakness, opportunity & Threats) analysis of external events/system (9) will produce “Quick wins” (35) and solutions based on complexity (Moderate/Complex/Futuristic) of solutions for ultimate information system (28), Chosen Transformed target system-virtual_company (27). The Implementation Phase (8) will refine and fine tune “platform specifics—reports and roadmaps (22 20)” and also refine and fine tune prioritize the solutions based on benefits with user's input and will be used in the possible solutions in the ultimate information system 28), Chosen Transformed target system-virtual_company (27).
The following Artificial intelligence based proposed Cognitive Intelligent Autonomous Transformation System adapters (23), as given below, will generate mini Cognitive system using customized Machine Learning/Robotic Process Automation Bots software robots/Virtual agents will be used to transform the current information system to the ultimate information system (28), more like an Autonomous Car except that in this case it will be information system—knows where to go from where they are and take their information system, organizations, processes along with it.
   Preliminary Adapters (Industry, Company, Region, Country, Size)
   Company Specific Adapters based on Application of system (eCommerce, Enterprise Resource Planning. BI, PLM), Lines of Business, Products/Services, Infrastructure—Present & Future, Historical reporting/BI—Present & Future.
Various Artificial intelligence based proposed Cognitive Intelligent Autonomous Transformation System Adapters (23) as given above will create the first cut Artificial intelligence based repository for this customer (proposed Cognitive Intelligent Autonomous Transformation System—Basic (24) which will be refined to proposed Cognitive Intelligent Autonomous Transformation System—Advanced (25), ultimate information system (28), Chosen Transformed target system-virtual_company (27) (which can be either the best version or even version than the ideal transformed target system), based on guidance from Master proposed Cognitive Intelligent Autonomous Transformation System Artificial intelligence repository (2) to produce the virtual company enterprise system for the customer (27) with foundation architecture provided by SAP Leonardo supporting Internet of Things, Blockchain, Artificial intelligence, Machine Learning, In-memory computing, Industry 4.0, Mobility.
During Pre implementation phase (13), IT Team prepares landscape, identifies custom programs that need to be upgraded to be compatible with target version, and also prepares project plan, checklist. roadmaps, cutover plan, data conversion plan.
During Implementation phase (14), execution of transformation system into Customer's CIATSFABI using all artifacts produced in the prior phases, to one of Brown-Field/System conversion, where possible, Global consolidation of regional systems for multi-nations, where possible or Green-Field/New implementation where it is not possible to convert and a new implementation is warranted. Data conversion of configuration data, Master Data, Transaction Data and historical data prior to Cutover and executing all cut-over activities to ensure Customer's CIATSFABI) (Actual) is realized well. During Post-implementation support (15) phase, all critical bugs are identified and after fixing the bugs, and after stabilizing system, Customer's CIATSFABI) (Actual) will be synchronized with Master CIATSFABI.
All the above phases Pre-Implementation, Implementation and Post-Implementation Phase (13 14 15) (Semi-Autonomous) by IT team with close coordination with the transformation system Master CIATSFABI.
Finally, during Continuous improvement phase (16), it constantly monitors the current system (Customer's CIATSFABI) with outputs from SWOT analysis, Master CIATSFABI and IndustryRef CIATSFABI) to see if there are newer versions are available and if so what benefits will be available under the latest version. The innovation cycle continues with improvements in Customer's target system with AI based Chatbot, RPA Bot, real-time AI scenarios that will provide competitive edge to the customer.

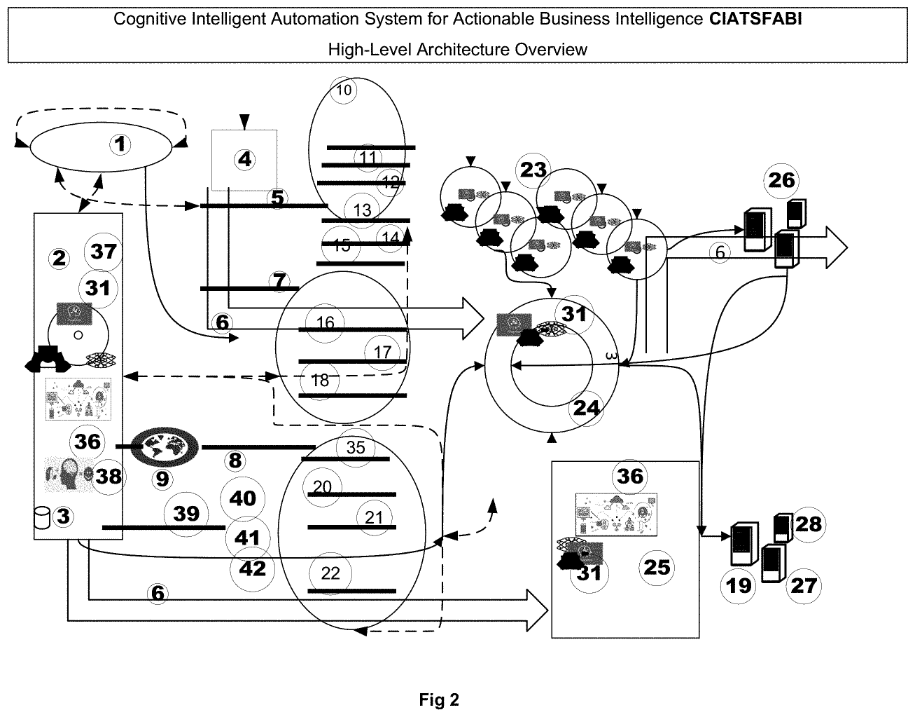

### FIG. 2—High Level Architecture Overview

| | |
|---|---|
| 1. | proposed Cognitive Intelligent Autonomous Transformation System |
| | Setup Wizard |
| 2. | Master Cognitive Intelligent Autonomous Transformation System |
| | for actionable Business intelligence (Master CIATSFABI) |
| 3. | Cognitive Super DB |
| 4. | Existing Information Systems |
| 5. | License |
| 6. | Connectivity Test |
| 7. | Pre-Discovery, Discovery, Analysis Phase (Autonomous/Semi- |
| | Autonomous by Master CIATSFABI) |
| 8. | Pre-implementation, implementation, Post- implementation Phase |
| | (semi-autonomous IT team), Continuous improvement Phase (process |
| | repeats) |
| 9. | SWOT from External Events/Systems |
| 10. | Enterprise Resource Planning |
| 11. | Business Warehouse/Business Intelligence |
| 12. | eCommerce |
| 13. | Big Data |
| 14. | Manufacturing Systems |
| 15. | PLM |
| 16. | Identify Opportunity Matrix |
| 17. | Understand Platform Specifics |
| 18. | Prioritize based on benefits/customer inputs |
| 19. | Virtual Company (Customer's CIATSFABI) |
| 20. | Complexity (Moderate, Complex, Futuristic) |
| 21. | Understand/Refine Platform Specifics |
| 22. | Prioritize including refinement based on benefits/customer |
| | inputs |
| 23. | Artificial intelligence based proposed Cognitive Intelligent |
| | Autonomous Transformation System Adapters |
| 24. | proposed Cognitive Intelligent Autonomous Transformation System |
| | (Basic) |
| 25. | proposed Cognitive Intelligent Autonomous Transformation System |
| | (Advanced) |
| 26. | Existing Enterprise Systems |
| 27. | Virtual company Enterprise Systems |
| 28. | Ideal Virtual Enterprise Systems proposed Cognitive intelligent |
| | automation solution/system |
| 29. | |
| 30. | |
| 31. | Artificial intelligence, Machine Learning, Deep Learning/Neural |
| | Networks, Robotic Process Automation |
| 32. | |
| 33. | |
| 34. | |
| 35. | Quick wins |
| 36. | SAP Leonardo Intelligent enterprise platform |
| 37. | IndustryRef CIATSFABI |
| 38. | Digital Assistants |
| 39. | Implementation Approach |
| 40. | Brown-Field/System Conversion |
| 41. | Landscape transformation |
| 42. | Green-Field/New implementation |
| 43. | Digital Assistant - AI Chatbot |
| 44. | Digital Assistant - RPA Bot |
| 45. | Digital Assistant - AI Scenarios |
| 46. | Digital Assistant - Online Info |
| 47. | |

Most of the explanations for FIG. 1 are also applicable to FIG. 2. Summary of High-Level Process (FIG. 2) has the following phases:

FIG. 2—High level Architecture overview comprises of Preliminary Discovery, Discovery, Analysis Adapter Module Analysis & Execution Phase and Pre-Implementation and Implementation Phase.

### Summary of Overview (FIG. 2) has the Following Phases:

Pre-discovery (7) creates IndustryRef CIATSFABI (37)) with the latest version available for the industry the company belong to along with the best practice configuration data. IndustryRef CIATSFABI) works with Customer's existing system and identifies initial set of digital assistants (AI chatbot (43), RPA Bot (44), and AI scenarios (45), access online info from internet (46).
Establish connectivity
   Setup Infrastructure assistant using Single-Sign On (SSO)
   Test Connectivity
   Using Cognitive management system (11), setup preliminary cognitive DB (3)
Generate Cognitive system using Adapter module
   Using Master CIATSFABI (2) and Adapter modules (5,6,7,8,9) create customer's CIATSFABI as the latest version available (Ideal_virtual 28) or one or more versions lower than the latest (Virtual_company (19)).
   Preliminary Adapter Module (23) analyze overview of configuration of customer's business system for specific industry, company, region, country and size settings.
   Adapter Module for detailed analysis of company settings for system (eCommerce, ERP, PLM, Mfg. Systems, CRM, Big Data and BW), Lines of Business (LOB), Products & Services, Infrastructure (Present & Future), Reporting (Present & Future).
Analyze existing customer's business system (4) (26).
Authenticate Licenses to ascertain privileges for customer's customized Cognitive AI based system.
Analyze all customer's business system (ERP, CRM, eCommerce, PLM, Manufacturing system, Bigdata, Analytics/BW).
Analyze industry specific and/or company specific implementation.

Discovery (7) phase provides goals, scopes, limitations for the eventual customer target system, generates adapters for reports, checklist roadmaps, automation scenarios Chatbot, RPA scenario, AI Scenario, finally propose customer target system.
Master CIATSFABI (2) setup wizards in conjunction with IndustryRef CIATSFABI (37) produce opportunity matrix, solution enhancement to Ideal_virtual (latest version 28), chosen virtual_company system (can be one or more versions lower than the latest 27).
Produce platform specifics (17), Prioritize solution based on user-inputs (18).
Automation analyzer Governance module ensures all Cognitive system are built correctly with referential integrity and also produces real-time percentage of completion.

Analysis (7) phase determines the appropriate transformation implementation—it can be one of green-field/new implementation or, Brown-field/System conversion or Global consolidation of several regional systems of multi-nationals. This phase also fine-tunes and finalizes Digital Assistants (RPA Bot (44), AI Chatbot (43), AI scenarios (45)). Initial implementation of transformation system will be for ERP, CRM and Analytics and other business systems later.
Analyze existing customer's business system (4) (26).
Authenticate Licenses to ascertain privileges for customer's customized Cognitive AI based system.
Analyze all customer's business system (ERP, CRM, eCommerce, PLM, Manufacturing system, Bigdata, Analytics/BW).
Analyze industry specific and/or company specific implementation.
Master CIATSFABI (2) setup wizards produce opportunity matrix, solution enhancement to Ideal_virtual (latest version 28), chosen virtual_company system (can be one or more versions lower than the latest 27).
Produce platform specifics (17).
Prioritize solution based on user-inputs (18).
Gap Analysis of actionable Business Intelligence reports, checklists & roadmaps, of Existing vs Proposed system and finalize target versions based on customer's selection.—Ideal_virtual (latest version 28) or virtual_company (lower versions) (19).
Finalize virtual proposed system aka Customers CIATSFABI (19) using Prebuild analyzer based on customer's preferences/suggestions, Cognitive Automation analyzer which reads company's existing configuration (25) and company specific database (26), adapter modules (23) to produce customer's CIATSFABI as the latest version available (Ideal_virtual 28) or one or more versions lower than the latest (Virtual_company19)

All the above phases Pre-Discovery, Discovery, Analysis Phase ((Autonomous/Semi-Autonomous) by Master CIATSFABI) (7) will be performed (Autonomously/Semi-Autonomously) by the Master CIATSFABI (2)) to propose Customer's CIATSFABI) (proposed) and IT team takes over to prepare for Pre-Implementation, Implementation and Post-implementation Phases (8) to generate Customers CIATSFABI) (Actual). Continuous improvement Phase (8) will look for opportunities to react to external/internal events, SWOT analysis and possible new version from vendors and the process repeats, possibly transforming to next version providing more competitive capabilities for the Customer—Customers CIATSFABI (proposed next version). To summarize the findings from above phase.
Pre-Discovery, Discovery, Analysis (7), phase results and SWOT analysis will be used by Master CIATSFABI (2) to produce Customer specific Cognitive System customers CIATSFABI system (Basic (24) (Quick wins)).
Upon further refinement of platform specifics and prioritizations produce Cognitive System (Advanced (25) (moderate complexity, complex, futuristic).
The Cognitive Intelligent Autonomous Transformation System architecture using Artificial intelligence, Machine Learning, Deep Learning/Neural Networks, Robotic Process Automation (31), supported by SAP Leonardo Intelligent enterprise platform (36) is designed to provide the necessary system, processes and technology to take existing information system (4) (26) and transform to provide the ideal ultimate information system for the customers (28), based on data driven machine learning and deep learning approach with lot of examples and training combined with process automation through explicit representations and rules aided by Robotic Process Automation and exception handling. Both Data driven Artificial intelligence and Process driven Artificial intelligence are controlled by a best practices Artificial intelligence database (Master proposed Cognitive intelligent automation solution/system) which itself is constantly being improved in each iteration which is officially released every 3 months.
Existing customer's information system (4) licenses (5) are authenticated, before analyzing all their system (Enterprise Resource Planning (10), Business Warehouse/Business Intelligence (11), eCommerce (12), Big Data (13), Product Lifecycle Management (15), Manufacturing Systems (14).) in any of the industry specific implementations (Consumer Industries (Consumer Products, Life Sciences, Retail, Fashion, Apparel Footwear Solutions, Wholesale products), Financial Services (Banking and Insurance), Energy (Oil & Gas, Chemicals, Utilities), Service Industries (Professional Services, Telecom, Media, Cargo Logistics, Engineering construction) Discrete Industries (Industrial machinery & components, Aerospace & Defense, Hitech, Automotive) to come with a Basic version of cognitive intelligent automation proposed Cognitive Intelligent Autonomous Transformation System Basic, as directed by the Master proposed Cognitive Intelligent Autonomous Transformation System hosted in a datacenter. All of the customer's system and datacenter system are tested for connectivity during wizard's Guided configuration.
Further Pre-Discovery, Discovery, Analysis (7) phase and Pre-implementation, Implementation and Post-implementation phases (8) including SWOT (Strength, weakness, opportunity & Threats) analysis of internal/external events (9) improve the customer's cognitive information system to be proposed Cognitive Intelligent Autonomous Transformation System Advanced which is used to Create/finetune/update the Customer's CIATSFABI (19) which can be either ideal system (target Ideal_virtual system—ultimate Transformed target system 28) or Virtual company information system (Virtual_company Chosen Transformed target system 27) for the specific company.
The Cognitive Intelligent Autonomous Transformation System (Master CIATSFABI) (2) in conjunction with IndustryRef CIATSFABI (37) generates proposed Cognitive Intelligent Autonomous Transformation System (Customer's CIATSFABI (19)), analyzes the existing information system (e.g. SAP system—Enterprise Resource Planning, Customer Relationship Management. BW, eCommerce.) with customer's intended ultimate platform (Ideal_virtual) and finds the best versions of the software as recommended by SAP through Product Availability Matrix. If an on-premise is desired by the customer but the best versions and features suiting customer's needs are only available in Cloud offering, the same will be recommended but the customer can still insist on only on-premise implementation with the understanding less optimal ultimate system will be available and that will be the company's transformed target system (virtual_company aka Customer's CIATSFABI).
The Master Cognitive Intelligent Autonomous Transformation System (Master CIATSFABI (2)) will use the Artificial intelligence repository (Cognitive Super DB (3)) using leading technologies—Machine Learning, Internet of Things, Block chain, Robotic Process Automation, In-memory computing, Deep Learning, Mobility and Artificial Intelligence Platform with the foundation architecture based on SAP Leonardo that provides Guided assistance (proposed Cognitive Intelligent Autonomous Transformation System setup Wizard (1)) (Configuration, testing, Proof-of-concept guidelines, System-wide testing, Data Migration, Integration testing, cutover assistance, roadmap and checklist for the implementation will be generated for the IT team for smooth implementation)
The proposed Cognitive Intelligent Autonomous Transformation System Solution is supported by Foundation Architecture—SAP Leonardo S4HANA (latest offering on Artificial intelligence and Enterprise Resource Planning platform from a vendor SAP) based Internet of Things and Artificial Intelligence environment, a combination of intelligent technologies, services, and industry solutions to provide innovative customized system for each customer.
All existing Enterprise information system (4) (26) for customer will be fitted with sensors and Internet of Things enabled, will be tested for Single-sign-on during connection test (6) with Master CIATSFABI (2), IndustryRef CIATSFABI (37), proposed Cognitive Intelligent Autonomous Transformation System CIATSFABI Basic (24), proposed Cognitive Intelligent Autonomous Transformation System CIATSFABI Advanced (25), Ideal_virtual (28), Virtual Company Enterprise Systems (27), to ensure that necessary configuration data, Master Data, Transaction data can be read and written with authorization as a proposed Cognitive Intelligent Autonomous Transformation System as a Superuser.
Proposed Cognitive Intelligent Autonomous Transformation System Setup Wizard (1), with Guidance from Artificial intelligence Master DB-Master proposed Cognitive Intelligent Autonomous Transformation System (2) in conjunction with IndustryRef CIATSFABI (37), after connection test (6) during Pre-Discovery, Discovery and Analysis Phase (7) will read from Existing information system (4) (26) will produce “identify Opportunity Matrix” which essentially identifies all solution advancement possible from current system to ultimate information system (28), Chosen Transformed target system-virtual_company (27). The Pre-Discovery, Discovery and Analysis Phase (7) also produces “platform specifics—reports (21) and roadmaps” which is also used in the possible solutions in the ultimate information system (28). Pre-Discovery, Discovery and Analysis Phase (8) also prioritize the solutions based on benefits with user's input (22) and will be used in the possible solutions in the ultimate information system (28), Chosen Transformed target system-virtual_company (27).
Proposed Cognitive Intelligent Autonomous Transformation System Setup Wizard (1), with Guidance from Artificial intelligence Master DB-Master proposed Cognitive intelligent automation solution/system (2), after connection test (6) during Pre-Implementation and Implementation Phase (8) will use Pre-Discovery, Discovery and Analysis Phase results (7) along with SWOT (Strength, weakness, opportunity & Threats) analysis of external events/system (9) will produce “Quick wins” (35) and solutions based on complexity (Moderate/Complex/Futuristic) (20) of solutions for ultimate information system (28), Chosen Transformed target system-virtual_company (27). The Implementation Phase (8) will refine and fine tune “platform specifics—reports (21) and roadmaps and also refine and fine tune prioritize the solutions based on benefits with user's input (22) and will be so customer 152451
used in the possible solutions in the ultimate information system 28), Chosen Transformed target system-virtual_company (27).
The following Artificial intelligence based proposed Cognitive Intelligent Autonomous Transformation System adapters (23), as given below, will generate mini Cognitive system using customized Machine Learning/Robotic Process Automation Bots software robots/Virtual agents will be used to transform the current information system to the ultimate information system (28), more like an Autonomous Car except that in this case it will be information system—knows where to go from where they are and take their information system, organizations, processes along with it.
   Preliminary Adapters (Industry, Company, Region, Country, Size)
   Company Specific Adapters based on==Application of system (eCommerce, Enterprise Resource Planning, BI, PLM), Lines of Business, Products/Services, Infrastructure—Present & Future, Historical reporting/BI—Present & Future.
Various Artificial intelligence based proposed Cognitive Intelligent Autonomous Transformation System Adapters (23) as given above will create the first cut Artificial intelligence based repository for this customer (proposed Cognitive Intelligent Autonomous Transformation System—Basic (24) which will be refined to proposed Cognitive Intelligent Autonomous Transformation System—Advanced (25), ultimate information system (28), Chosen Transformed target system-virtual_company (27) (which can be either the best version or even version than the ideal transformed target system), based on guidance from Master proposed Cognitive Intelligent Autonomous Transformation System Artificial intelligence repository (2) to produce the virtual company enterprise system for the customer (27) with foundation architecture provided by SAP Leonardo supporting Internet of Things, Blockchain, Artificial intelligence, Machine Learning, In-memory computing, Industry 4.0, Mobility.

During Pre implementation phase (8), IT Team prepares landscape, identifies custom programs that need to be upgraded to be compatible with target version, and also prepares project plan, checklist, roadmaps, cutover plan, data conversion plan.

During Implementation phase (8), execution of transformation system into Customer's CIATSFABI using all artifacts produced in the prior phases, to one of Brown-Field/System conversion, where possible, Global consolidation of regional systems for multi-nations, where possible or Green-Field/New implementation where it is not possible to convert and a new implementation is warranted. Data conversion of configuration data, Master Data, Transaction Data and historical data prior to Cutover and executing all cut-over activities to ensure Customer's CIATSFABI) (Actual) is realized well.
Automation analyzer Governance module ensures all Cognitive system are built correctly with referential integrity and also produces real-time percentage of completion.

During Post-implementation support (8) phase, all critical bugs are identified and after fixing the bugs, and after stabilizing system, Customer's CIATSFABI) (Actual) will be synchronized with Master CIATSFABI.

All the above phases Pre-Implementation, Implementation and Post-Implementation Phase (8) (Semi-Autonomous) by IT team with close coordination with the transformation system Master CIATSFABI.
Update Master CIATSFABI (2) and Cognitive DB (3) with customer's CIATSFABI finalized system (33).

Finally, during Continuous improvement phase (8), it constantly monitors the current system (Customer's CIATSFABI) with outputs from SWOT analysis, Master CIATSFABI and IndustryRef CIATSFABI) to see if there are newer versions are available and if so what benefits will be available under the latest version. The innovation cycle continues with improvements in Customer's target system with AI based Chatbot, RPA Bot, real-time AI scenarios that will provide competitive edge to the customer.

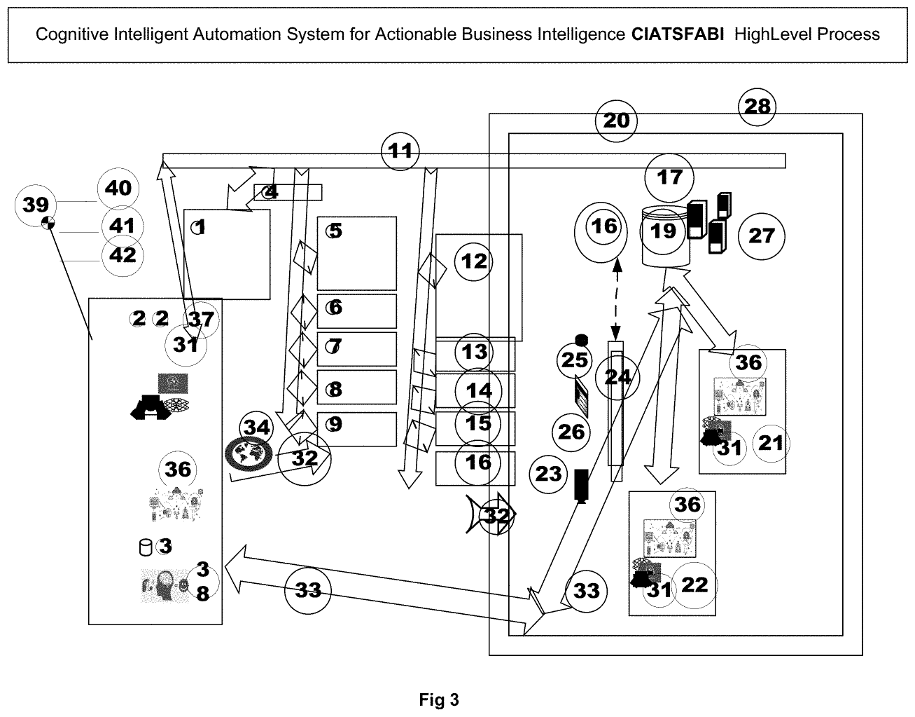

### FIG. 3—High Level Process Diagram

| | |
|---|---|
| 1. | CIATSFABI setup wizard including Preliminary Adapters config- |
| | uration wizard (Industry, Company, Region, Country, Size) |
| 2. | Master Cognitive Intelligent Autonomous Transformation System |
| | for actionable Business intelligence (Master CIATSFABI) |
| 3. | Cognitive Super DB |
| 4. | Existing Company |
| 5. | Company Specific Adapters on system (eCommerce, Enterprise |
| | Resource Planning, Business Intelligence (BI), Product Life |
| | Cycle Management (PLM) |
| 6. | Company Specific Adapters based on Line of Business (LOB) |
| 7. | Company Specific Adapters based on Products/Services |
| 8. | Company Specific Adapters based on Infrastructure - Present & |
| | Future |
| 9. | Company Specific Adapters based on Historical reporting/BI - |
| | Present & Future |
| 10. | Virtual company with Cognitive intelligence (Customer's |
| | CIATSFABI) |
| 11. | Cognitive Management Systems |
| 12. | Business Score Card (BSC), Infrastructure, corporate performance, |
| | cyber security, vulnerability, new products/services, R&D, Strategic |
| | Information system |
| 13. | Recommended system, Business Intelligence reports, Actions |
| 14. | Rejected by Customers incl. reasons and when this can be revisited |
| 15. | Evolving Cognitive BI trends within the company |
| 16. | Evolving External cognitive BI trends |
| 17. | Prebuild Analyzer |
| 18. | cognitive intelligent automation prebuild wizard |
| 19. | Company Virtual proposed Cognitive intelligent automation solution/ |
| | system |
| 20. | Cognitive Automation Analyzer |
| 21. | PreBuild_BOTS software robots/Virtual agents proposed Cognitive |
| | Intelligent Autonomous Transformation System (Basic) |
| 22. | proposed Cognitive Intelligent Autonomous Transformation System |
| | (Advanced) |
| 23. | Monitor Progress |
| 24. | Governance |
| 25. | Company Configuration |
| 26. | Company knowledgebase |
| 27. | |
| 28. | Ideal Virtual Enterprise system |
| 29. | |
| 30. | |
| 31. | Artificial intelligence, Machine Learning, Deep Learning/Neural |
| | Networks |
| 32. | connectivity test |
| 33. | Update/Finetune |
| 34. | SWOT from External events |
| 35. | |
| 36. | SAP Leonardo Intelligent enterprise platform |
| 37. | IndustryRef CIATSFABI |
| 38. | Digital Assistants |
| 39. | Implementation Approach |
| 40. | Brown-Field/System Conversion |
| 41. | Landscape transformation |
| 42. | Green-Field/New implementation |

FIG. 3—High level Process Diagram comprises of Establish connectivity phase, Generate Cognitive system using Adapter module, Gap Analysis phase of actionable Business Intelligence reports, checklists & roadmaps, of Existing vs Proposed system, finalize target version phase, Governance Phase and update Master CIATSFABI phase.

Most of the explanations for FIG. 2 are also applicable to FIG. 3. Summary of High-Level Process (FIG. 3) has the following phases:
n Establish connectivity
   Setup Infrastructure assistant using Single-Sign On (SSO)
   Test Connectivity
   Using Cognitive management system (11), setup preliminary cognitive DB (3)
Generate Cognitive system using Adapter module
   Using Master CIATSFABI (2) and Adapter modules (5,6,7,8,9) create customer's CIATSFABI as the latest version available (Ideal_virtual 28) or one or more versions lower than the latest (Virtual_company (19)).
Gap Analysis of actionable Business Intelligence reports, checklists & roadmaps, of Existing vs Proposed system and finalize target versions based on customer's selection.—Ideal_virtual (latest version 28) or virtual_company (lower versions) (19).
Finalize virtual proposed system aka Customer's CIATSFABI (10) using Prebuild analyzer (17) based on customer's preferences/suggestions, Cognitive Automation analyzer (20) which reads company's existing configuration (25) and company specific database (26), adapter modules (5,6,7,8,9) to produce customer's CIATSFABI as the latest version available (Ideal_virtual 28) or one or more versions lower than the latest (Virtual_company19)
Automation analyzer Governance module ensures all Cognitive system are built correctly with referential integrity and also produces real-time percentage of completion.
   Update Master CIATSFABI (2) and Cognitive DB (3) with customer's CIATSFABI finalized system (33).
Setup using infrastructure assistant Single Sign-on (SSO) and Secured infrastructure. Test connectivity (32)
Access Cognitive Management (11) system to setup preliminary Cognitive DB for the industry, company using Machine Learning/Robotic Process Automation BOTS software robots/Virtual agents
The Cognitive Intelligent Autonomous Transformation System architecture using Artificial intelligence, Machine Learning, Deep Learning/Neural Networks, Robotic Process Automation (31), supported by SAP Leonardo Intelligent enterprise platform (36) is designed to provide the necessary system, processes and technology to take existing information system (4) and transform to provide the ideal ultimate information system for the customers (28), based on data driven machine learning and deep learning approach with lot of examples and training combined with process automation through explicit representations and rules aided by Robotic Process Automation and exception handling. Both Data driven Artificial intelligence and Process driven Artificial intelligence are controlled by a best practices Artificial intelligence database (Master proposed Cognitive intelligent automation solution/system) which itself is constantly being improved in each iteration which is officially released every 3 months.
   The following Artificial intelligence based proposed Cognitive Intelligent Autonomous Transformation System adapters (1)(5)(6)(7)(8)(9), as given below, will generate mini Cognitive system using customized Machine Learning/Robotic Process Automation BOTS software robots/Virtual agents will be used to transform the current information system to the ultimate information system (28) and customer chosen transformed target system—Virtual company with Cognitive Intelligence (Customer's CIATSFABI 10), more like an Autonomous Cars except that in this case it will be information system—knows where to go from where they are and take their system, organizations, processes along with it
      CIATSFABI setup wizard including Preliminary Adapters configuration wizard (Industry, Company, Region, Country, Size) (1)
      Existing Company Specific Adapters based on system (eCommerce, Enterprise Resource Planning, Business Intelligence (BI), Product Life Cycle Management (PLM) (5), Line of Business (LOB) (6), Products/Services (7), Infrastructure—Present & Future (8), Historical reporting/BI—Present & Future (9).
   Analyze Past, present and future Business Intelligence reports/activities setup in existing system with the proposed from Cognitive automation system. Measure the Gaps. Guidelines, recommendations using Cognitive automation system for new infrastructure, new information system, new products and services. Get feedback from customers, grade, evaluate and finalize the transformed target system including the versions. Additional benefits of the Cognitive Intelligent Automation for Alignment of corporate mission, goals and objectives with Business Intelligence needs provided by current/proposed company initiatives enhanced by the recommendations provided by Ideal_virtual (28) and virtual_company (10) of Cognitive Intelligent Autonomous Transformation System (proposed Cognitive intelligent automation solution/system), (10), identifying the gaps in their existing initiatives and approach and provide suitable reports to close the gap.
   The Ideal_virtual company with cognitive intelligence (28) after analyzing Business Score Card (BSC), Infrastructure, corporate performance, cyber security, vulnerability, new products/services, R&D, Strategic Information system (12), produces the following analytical reports which are either approved or rejected by user management.
      Recommended system, Business Intelligence (BI) Reports, Actions (13)
      Rejected by Customers incl. reasons and when this can be revisited (14)
      Evolving Cognitive Business Intelligence (BI) trends within the company (15)
      Evolving External cognitive Business Intelligence (BI) trends (16)
   This user management input is fed to Prebuild analyzer (17) to finalize company specific Virtual proposed Cognitive Intelligent Autonomous Transformation System i.e., the absolute ideal transformed target system for the specific company (10).
   The Cognitive Automation Analyzer (20) reads current company configuration (25) of system and additional company specific knowledgebase (26) and uses Various Artificial intelligence based proposed Cognitive Intelligent Autonomous Transformation System setup wizard including Adapters wizard (1)(5)(6)(7)(8)(9) as given above will create the first cut Artificial intelligence based repository for this customer (proposed Cognitive Intelligent Autonomous Transformation System—Basic (21) which will be refined, based on guidance from Master proposed Cognitive Intelligent Autonomous Transformation System Artificial intelligence repository (2) Ideal_virtual (28) and the virtual company enterprise system for the customer (10 Customer's CIATSFABI) to proposed Cognitive Intelligent Autonomous Transformation System—Advanced (22) with foundation architecture provided by SAP Leonardo supporting Internet of Things, Blockchain, Artificial intelligence, Machine Learning, In-memory computing, Industry 4.0, Mobility solutions.
      CIATSFABI setup wizard including Preliminary Adapters configuration wizard (Industry, Company, Region, Country, Size) (1)
      Existing Company Specific Adapters based on system (eCommerce, Enterprise Resource Planning, Business Intelligence (BI), Product Life Cycle Management (PLM) (5), Line of Business (LOB) (6), Products/Services (7), Infrastructure—Present & Future (8), Historical reporting/BI—Present & Future (9).
   The Cognitive Automation Analyzer Governance (24) makes sure it ensures all current system configuration, Master data, and (sample/full) transaction data are transferred and validated with user inputs to Ideal_virtual (28), Virtual Company proposed Cognitive Intelligent Autonomous Transformation System (19), proposed Cognitive Intelligent Autonomous Transformation System—Basic (21), proposed Cognitive Intelligent Autonomous Transformation System—Advanced (22), The progress of the transfer and validation are monitored (23) along with percentage of completion.
   Fine tune Cognitive DB repository (3) for the Master proposed Cognitive Intelligent Autonomous Transformation System (2) with company specific information incl. details on Information system. How well did the new solution help the company—SWOT (Strength, weakness, opportunity & Threats) analysis (34), recommendations for improvements to Cognitive Automation system in the next iteration. The results are once again used to update the Master proposed Cognitive Intelligent Autonomous Transformation System (2).

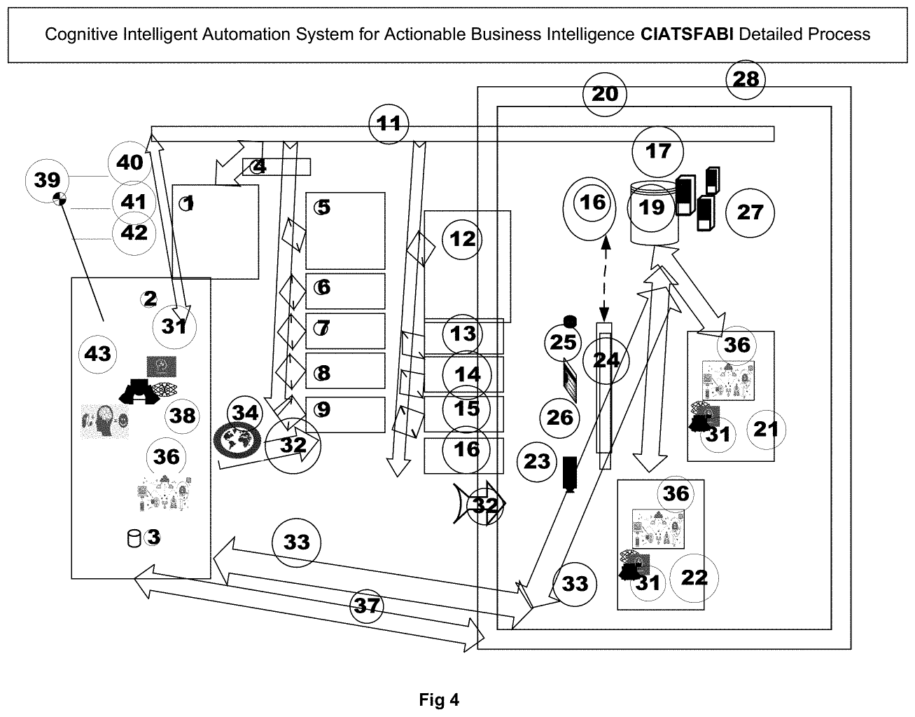

### FIG. 4—Detailed Process Diagram

| | |
|---|---|
| 1. | CIATSFABI setup wizard including Preliminary Adapters config- |
| | uration wizard |
| 2. | Master proposed Cognitive intelligent automation solution/system |
| 3. | Cognitive Super DB |
| 4. | Existing Company |
| 5. | Company Specific Adapters on system (eCommerce, Enterprise |
| | Resource |
| 6. | Company Specific Adapters based on Line of Business (LOB) |
| 7. | Company Specific Adapters based on Products/Services |
| 8. | Company Specific Adapters based on Infrastructure - Present & |
| | Future |
| 9. | Company Specific Adapters based on Historical reporting/BI - |
| | Present & Future |
| 10. | Virtual company with Cognitive intelligence (Customers |
| | CIATSFABI) |
| 11. | Cognitive Management Systems |
| 12. | Business Score Card (BSC), Infrastructure, corporate performance, |
| | cyber security, |
| 13. | Recommended system, Business Intelligence reports, Actions |
| 14. | Rejected by Customers incl. reasons and when this can be revisited |
| 15. | Evolving Cognitive BI trends within the company |
| 16. | Evolving External cognitive BI trends |
| 17. | Prebuild Analyzer |
| 18. | cognitive intelligent automation prebuild wizard |
| 19. | Company Virtual proposed Cognitive intelligent automation solution/ |
| | system |
| 20. | Cognitive Automation Analyzer |
| 21. | PreBuild_BOTS software robots/Virtual agents proposed Cognitive |
| | Intelligent |
| 22. | proposed Cognitive Intelligent Autonomous Transformation System |
| | Advanced |
| 23. | Monitor Progress |
| 24. | Governance |
| 25. | Company Configuration |
| 26. | Company knowledgebase |
| 27. | Virtual company enterprise system |
| 28. | Ideal Virtual Enterprise Systems proposed Cognitive intelligent |
| | automation solution |
| 29. | |
| 30. | Releases every 3 months |
| 31. | Artificial intelligence, Machine Learning, Deep Learning/Neural |
| | Networks (DL/NN) |
| 32. | connectivity test |
| 33. | Update/synchronize Master CIATSFABI and Customer CIATSFABI |
| 34. | External Events |
| 35. | |
| 36. | SAP Leonardo Intelligent enterprise platform |
| 37. | Scheduled Master CIATSFABI Release every 3 months |
| 38. | Digital Assistants |
| 39. | Implementation Approach |
| 40. | Brown-Field/System Conversion |
| 41. | Landscape transformation |
| 42. | Green-Field/New implementation |
| 43. | IndustryRef CIATSFABI |

FIG. 4—Detailed Process Diagram comprise of Prebuild analyzer phase with machine learning, RPA scripts to generate & fine-tune proposed Customer's CIATSFABI and Major scheduled release of Master CIATSFABI phase to regenerate customer's CIATSFABI. Most of the explanations for FIGS. 0, 1 and 2 are also applicable to FIG. 4. Summary of Detailed Process (FIG. 4) has the following phases:
Prebuild analyzer to generate & fine-tune proposed Customer's CIATSFABI—Basic, Advanced, Ideal_virtual and virtual_company using customized RPA modules
   RPA modules for automation setup, analyze system, setup SSO, Refinement based on License, Analyze mission, goals, objectives, eCommerce solutions, ERP, competitive analysis, LOB Issues & Opportunities, cross system intelligence & opportunities, BI applications, Gap analysis and mitigation
Release latest version of Master CIATSFABI every 3 months (30 37) with architectural platform (36) and updates from External events (34) at customer's initiation can generate Customer's CIATSFABI—Basic (21), Advanced (22), Ideal_virtual (28 latest version) and virtual_company (27/19/10 may be lower version(s)) and finally rework/regenerate all actionable Business Intelligence reports, checklists & roadmaps,
The Cognitive Intelligent Autonomous Transformation System architecture using Artificial intelligence, Machine Learning, Deep Learning/Neural Networks, Robotic Process Automation (31), supported by SAP Leonardo Intelligent enterprise platform (36) is designed to provide the necessary system, processes and technology to take existing information system (4) and transform to provide the ideal ultimate information system for the customers (28), based on data driven machine learning and deep learning approach with lot of examples and training combined with process automation through explicit representations and rules aided by Robotic Process Automation and exception handling. Both Data driven Artificial intelligence and Process driven Artificial intelligence are controlled by a best practices Artificial intelligence database (Master proposed Cognitive intelligent automation solution/system) which itself is constantly being improved in each iteration which is officially released every 3 months. (30 37).
The following Artificial intelligence based proposed Cognitive Intelligent Autonomous Transformation System setup wizard including Preliminary Adapters configuration wizard (1)(5)(6)(7)(8)(9), as given below, will generate mini Cognitive system using customized Machine Learning/Robotic Process Automation BOTS software robots/Virtual agents will be used to transform the current information system to the ultimate information system (28) and customer chosen transformed target system—Virtual company with Cognitive Intelligence (10 Customer's CIATSFABI), more like an Autonomous Cars except that in this case it will be information system—knows where to go from where they are and take their system, organizations, processes along with it
   CIATSFABI setup wizard including Preliminary Adapters configuration wizard (industry, Company, Region, Country, Size) (1)
   Existing Company Specific Adapters based on system (eCommerce, Enterprise Resource Planning, Business Intelligence (BI), Product Life Cycle Management (PLM) (5), Line of Business (LOB) (6), Products/Services (7), Infrastructure—Present & Future (8), Historical reporting/BI—Present & Future (9)
The Ideal_virtual company with cognitive intelligence (28) after analyzing Business Score Card (BSC), Infrastructure, corporate performance, cyber security, vulnerability, new products/services, R&D, Strategic Information system (12), produces the following analytical reports which are either approved or rejected by user management.
   Recommended system, Business Intelligence (BI) Reports, Actions (13)
   Rejected by Customers incl. reasons and when this can be revisited (14)
   Evolving Cognitive Business Intelligence (BI) trends within the company (15)
   Evolving External cognitive Business Intelligence (BI) trends (16)
This user management input is fed to Prebuild analyzer (17) and cognitive intelligent automation prebuild wizard (18) to finalize company specific Virtual proposed Cognitive Intelligent Autonomous Transformation System i.e., the absolute ideal transformed target system for the specific company (28).
Official release of Master proposed Cognitive Intelligent Autonomous Transformation System Artificial Intelligence Database (2) is released every 3 months (28) and with external events/system (29), the Cognitive system—Basic (21), Advanced (22), Ideal_virtual (34) and virtual_company (10) are reworked and all actionable Business Intelligence reports, checklists & roadmaps, are regenerated.
Establish connectivity
   Setup Infrastructure assistant using Single-Sign On (SSO)
   Test Connectivity (32)
   Using Cognitive management system (11), setup preliminary cognitive DB (3)
Update Master CIATSFABI (2) and Cognitive DB (3) with customer's CIATSFABI finalized system (33).
The following Machine Learning/Robotic Process Automation BOTS software robots/Virtual agents is used in Prebuild to generate and fine-tune proposed Cognitive Intelligent Autonomous Transformation System Basic, Advanced, Ideal_virtual and virtual_company cognitive system.
   BIS_AttachmateRobotic Process Automation To setup config tables and the proposed Cognitive Intelligent Autonomous Transformation System for the customer—industry, company, geography, country or multi-national setup
   BIS_AnalyzelSROA To analyze existing customer information system, read system landscape directory (SLD) and setup detailed configuration including various adapters (ecommerce, Enterprise Resource Planning.)
   BIS_SSOTestRobotic Process Automation Detailed Single Sign-On (SSO) Setup with customer system using SSO, do connectivity and semantic test
   BIS_Cognitive_SysRobotic Process Automation on Cloud/On-premise including license type (#of system, modules, interfaces, BI Sources, Reports, countries, employees, size, complexity, #products/Services, ecommerce, Enterprise Resource Planning, Supply Chain Management, Master Data Governance, Forecasting, Business Intelligence
   BIS_Analyze_Mission_toActionRobotic Process Automation to setup, analyze Missions to Goals & Objectives to various information system to support it
   BIS_InfrastructureRobotic Process Automation to analyze infrastructure setup, issues at hand, potential for fine tuning, SLA monitoring
   BIS_eCommerceAna_Robotic Process Automation SAP eCommerce with Hybris setup ecommerce, analyze complexities, Issues, potential improvements
   BIS_IndSoInAnaRobotic Process Automation to analyze industry specific solution, Issues, potential improvements.
   BIS_ERP_SAP Robotic Process Automation to analyze Enterprise Resource Planning system all modules from Sales & Distribution, Procurement, Finance, controlling, Production planning, Master data mgmt. and governance, Product life cycle management
   BIS_Competitive_AnaRobotic Process Automation to do competitive analysis and derive potential intelligence reports
   BIS_AnaLOBRobotic Process Automation to analyze current Lines of Business (LoB) Issues, potential opportunities
   BIS_AnaPLMRobotic Process Automation to analyze product/service offerings, issues, opportunities
   BIS_AnaBIRobotic Process Automation to analyze current Business Intelligence (BI) System, Issues, possible improvements
   BIS_IntegrationRobotic Process Automation to analyze cross system intelligence issues, opportunities
   BIS_VirtualCompanyRobotic Process Automation to analyze all potential BI opportunities for the ideal company setup
   BIS_VirtualGapAnaRobutic Process Automation to analyze current BI initiatives and what is possible, reports to mitigate the gaps
   BIS_AnaWLRobltic Process Automation to analyze synchronization needs between customers proposed Cognitive Intelligent Autonomous Transformation System and the Master proposed Cognitive intelligent automation solution system

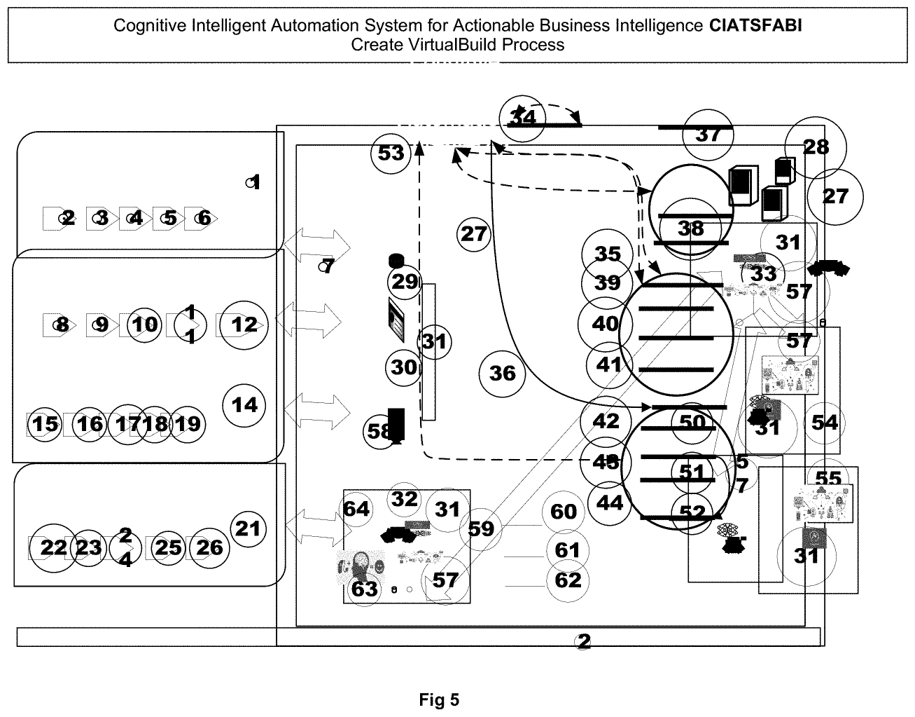

### FIG. 5—Steps to Create Virtual Build System

| | |
|---|---|
| 1. | Company |
| 2. | Vision |
| 3. | Mission |
| 4. | Objectives |
| 5. | Strategy |
| 6. | Action Plan |
| 7. | Existing Systems |
| 8. | Enterprise Resource Planning, eCommerce, Business Warehouse |
| | (BW). |
| 9. | Industry Solution |
| 10. | Core Business Process, Reports, Interfaces (RICEF) |
| 11. | Automation Opportunities |
| 12. | Priorities |
| 13. | |
| 14. | Best Practice Gaps -Inter-Intra Industry |
| 15. | Most used Business Process in the industry |
| 16. | Most used Business Process across the industries |
| 17. | Core Business Processes |
| 18. | Automation Opportunities |
| 19. | User input Priorities |
| 20. | |
| 21. | User/Management Input-Prioritization |
| 22. | Infrastructure |
| 23. | Product Portfolio Choices |
| 24. | Core Business Process, Reports, Interfaces (RICEF) Choices |
| 25. | Automation Opportunities |
| 26. | User input Priorities |
| 27. | Cognitive Intelligent Automation Setup Wizard |
| 28. | Cognitive Automation Analyzer |
| 29. | Company Configuration |
| 30. | Company Knowledgebase |
| 31. | Governance |
| 32. | Master proposed Cognitive intelligent automation solution/system |
| 33. | Virtual company proposed Cognitive Intelligent Autonomous |
| | Transformation |
| 34. | License Validation Phase |
| 35. | Discovery Phase |
| 36. | Implementation Phase |
| 37. | Enterprise Resource Planning, eCommerce, Business Warehouse. |
| 38. | Manufacturing Systems Product Lifecycle Management, Big Data |
| 39. | Identify Opportunity Matrix |
| 40. | Understand Platform Specifics |
| 41. | Prioritize based on Benefits/Customer Inputs |
| 42. | Quick wins complexity |
| 43. | Understand Platform Specifics |
| 44. | Prioritize based on Benefits/Customer Inputs |
| 45. | Artificial intelligence, Machine Learning, Cognitive, Deep |
| | Learning/Neural |
| 46. | |
| 47. | |
| 48. | SAP Applications |
| 49. | |
| 50. | Moderate |
| 51. | Complex |
| 52. | Futuristic |
| 53. | VirtualBuild Analyzer |
| 54. | PreBuild_BOTS software robots/Virtual agents proposed Cognitive |
| | Intelligent |
| 55. | proposed Cognitive Intelligent Autonomous Transformation System |
| 56. | Ideal Virtual Enterprise Systems proposed Cognitive intelligent |
| | automation |
| 57. | SAP Leonardo Intelligent enterprise platform |
| 58. | Monitor |
| 59. | Implementation Approach |
| 60. | Brown-Field/System Conversion |
| 61. | Landscape transformation |
| 62. | Green-Field/New implementation |
| 63. | Digital Assistants |
| 64. | IndustryRef CIATSFABI |

FIG. 5 Create Virtual Build process with setup wizard has License validation phase, Discovery phase, and implementation phase in conjunction with Master CIATSFABI fine-tunes proposed Customer's CIATSFABI—Basic, Advanced, Ideal_virtual & virtual_company.

Most of the explanations for FIGS. 1, 2, 3 and 4 are also applicable to FIG. 5. Summary of Create Virtual Build process (FIG. 5) has the following phases:
FIG. 5 Create Virtual Build process with setup wizard (27) has License validation phase (34), Discovery phase (35), and implementation phase (36) in conjunction with Master CIATSFABI (32) under AI Platform (57) transform existing system (7) and fine-tunes proposed Customer's CIATSFABI—Basic, Advanced, Ideal_virtual and virtual_company.
Create Virtual Build process using prebuild wizard (53) in conjunction with Master CIATSFABI fine-tunes proposed Customer's CIATSFABI—Basic (54), Advanced (55), Ideal_virtual and virtual_company (56).
Cognitive Intelligent Automation Setup Wizard (27) has License validation phase deciding the privileges, Discovery phase which identifies opportunity, platform specifics, finalize priorities and implementation phase that produces Ideal_virtual (latest version) virtual_company (lower versions) based on quick wins, complexity (moderate, complex, futuristic).
The proposed Cognitive Intelligent Autonomous Transformation System Cognitive Intelligent Automation Setup Wizard/Automation analyzer wizard (28) using Artificial Intelligence, Machine Learning/Robotic Process Automation, Neural Networks, analyze the Company profile (vision (2), mission (3), objectives (4), Strategy (5), Action Plan (6)), Existing system (Enterprise Resource Planning, eCommerce, Customer Relationship Management, BW (8), Industry Solution (9), Core Business Process, Reports, Interfaces (RICEF) (10), Automation Opportunities (11), Priorities (12)), Gaps in Best Practice for Inter and Intra Industry (14) (Most used business process within the industry (15), Most used business process across the industries (16), Core business process (17), Automation opportunities (18), User Input Priorities (19), User Management Input Prioritization (21) (Infrastructure (22), Product portfolio choices (23), RICEF Choices (24), Automation opportunities (25), User Input Priorities (26), to produce the ideal transformed target system called Ideal_virtual and can also be the transformed target system for the company called Virtual_company using the process VirtualBuild, as orchestrated by the Master proposed Cognitive Intelligent Autonomous Transformation System which is hosted in a datacenter.
Cognitive Intelligent Automation setup Wizard has three different phases
   License validation Phase (34) Machine Learning/Robotic Process Automation BOTS software robots/Virtual agents for Enterprise Resource Planning, eCommerce, Customer Relationship Management, BW, Manufacturing system, Product Lifecycle Management (PLM), Big Data Analytics (37) (38) depending on what licensing were purchased by customer.
   During Discovery Phase (35), identifies the Opportunity (39), understand platform specifics (40 43) and finalize priorities based on benefits and customer input (41 44)
   During Implementation Phase (36), Produces a Quick wins (42) based virtual company solution (33), different virtual company solution depending on the complexity (Moderate (50), Complex (51) and Futuristic (52). The virtual company solution is Ideal Virtual Enterprise Systems proposed Cognitive Intelligent Autonomous Transformation System (56) (for complexity as Futuristic (52)) and it can be the chosen transformed target system—virtual company proposed Cognitive Intelligent Autonomous Transformation System (33) which can be Virtual_company on Quick wins/Moderate/complex/futuristic with entire process being monitored (58) as part of governance (31) process.
   Cognitive Automation analyzer (28) which reads company's existing configuration (29) and company specific database (30), adapter modules to produce customer's CIATSFABI as the latest version available (Ideal_virtual 56) or one or more versions lower than the latest (Virtual_company33).
   The Cognitive Intelligent Autonomous Transformation System architecture using Artificial intelligence, Machine Learning, Deep Learning/Neural Networks, Robotic Process Automation (45), supported by SAP Leonardo Intelligent enterprise platform (57) is designed to provide the necessary system (48), processes and technology to take existing information system (4) and transform to provide the ideal ultimate information system for the customers (28), based on data driven machine learning and deep learning approach with lot of examples and training combined with process automation through explicit representations and rules aided by Robotic Process Automation and exception handling. Both Data driven Artificial intelligence and Process driven Artificial intelligence are controlled by a best practices Artificial intelligence database (Master proposed Cognitive intelligent automation solution/system) which itself is constantly being improved in each iteration which is officially released every 3 months. (30 37).

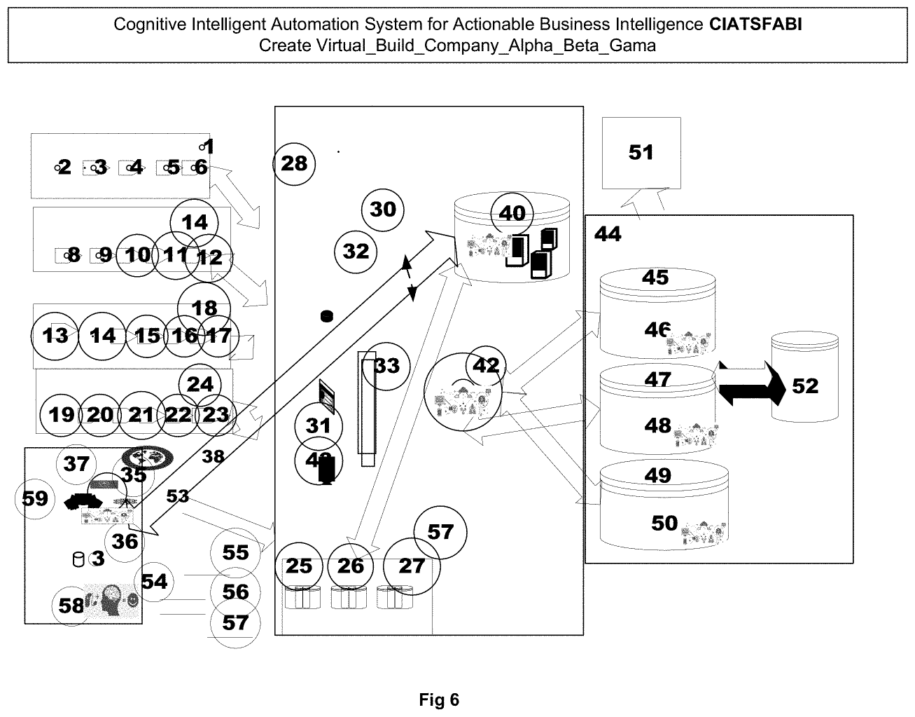

### FIG. 6—Steps to Create Prebuild_ABG Systems

| | |
|---|---|
| 1. | Company |
| 2. | Vision |
| 3. | Mission |
| 4. | Objectives |
| 5. | Strategy |
| 6. | Action Plan |
| 7. | Enterprise Resource Planning (ERP), eCommerce, Business |
| | Warehouse. |
| 8. | Industry Solution |
| 9. | Core Business Process, Reports, Interfaces (RICEF) |
| 10. | Automation Opportunities |
| 11. | Priorities |
| 12. | Existing Systems |
| 13. | Most used Business Process in the industry |
| 14. | Most used Business Process across the industries |
| 15. | Core Business Processes |
| 16. | Automation Opportunities |
| 17. | User input Priorities |
| 18. | Best Practice Gaps -Inter-Intra Industry |
| 19. | Infrastructure |
| 20. | Product Portfolio Choices |
| 21. | RICEF Choices |
| 22. | Automation Opportunities |
| 23. | User input Priorities |
| 24. | User/Mgmt. Input-Prioritization |
| 25. | C1_ABGSystem |
| 26. | C2_ABGSystem |
| 27. | C3_ABGSystem |
| 28. | Prebuild Analyzer |
| 29. | Cognitive Intelligent Automation Prebuild Wizard |
| 30. | Company Configuration |
| 31. | Company Knowledgebase |
| 32. | Cognitive Automation Analyzer |
| 33. | Governance |
| 34. | Neural Networks (NN) |
| 35. | Artificial intelligence, Machine Learning, Deep Learning/ |
| | Neural Networks, |
| 36. | SAP Leonardo Intelligent enterprise platform |
| 37. | Master proposed Cognitive intelligent automation solution/ |
| | system |
| 38. | Releases every 3 months |
| 39. | External Events |
| 40. | Virtual_company Company proposed Cognitive Intelligent |
| | Autonomous |
| 41. | Robotic Process Automation_BOTS_0001 Robotic Process |
| | Automation |
| 42. | PreBuild_BOTS proposed Cognitive intelligent automation |
| | solution/system |
| 43. | Monitor in Progress |
| 44. | Company1_ABGSystem |
| 45. | Quick wins with Robotic Process Automation Artificial intelli- |
| | gence NN |
| 46. | Company1_Alpha_proposed Cognitive intelligent automation |
| | solution/ |
| 47. | Moderate with Robotic Process Automation Artificial intelli- |
| | gence NN |
| 48. | Company1_Beta_proposed Cognitive intelligent automation |
| | solution/system |
| 49. | Complex with Robotic Process Automation Artificial intelli- |
| | gence NN |
| 50. | Company1_Gama_proposed Cognitive intelligent automation |
| | solution/ |
| 51. | Report to C level Executives - Checklist, Roadmaps. |
| 52. | Company Info Systems |
| 53. | Trigger Alerts for downloading latest version available |
| 54. | Implementation Approach |
| 55. | Brown-Field/System Conversion |
| 56. | Landscape transformation |
| 57. | Green-Field/New implementation |
| 58. | Digital Assistants |
| 59. | IndustryRef CIATSFABI |
| 60. | |
| 61. | |
| 62. | Ideal Virtual Enterprise Systems proposed Cognitive intelligent |
| | automation |

FIG. 6 Create Pre-Build ABG fine-tunes CIATSFABI with Prebuild process (FIG. 5) Quick win generates Company1_Alpha, Moderate complexity generates Company1_Beta, complex generates Company1_Gama and futuristic generates Ideal-virtual (Latest version). Finally, company1_ABG system interact with customer's system to fine-tune Idealvirtual (Latest version), virtual_company (lower versions) and also support multi-national companies.

Most of the explanations for FIGS. 1,2, 3, 4 and 5 are also applicable to FIG. 6.

Summary of Create Pre-Build ABG system (FIG. 6) has the following phases:
FIG. 6 Create PreBuild_ABG with setup wizard (29) uses Prebuild process (from FIG. 5) which has License validation phase, Discovery phase, and implementation phase in conjunction with Master CIATSFABI (37) under AI Platform (36) transform existing system (12) and fine-tunes proposed Customer's CIATSFABI—Basic (46), Advanced (48 50 62), Ideal_virtual (62) and virtual-company (40).
Prebuild ABG system fine-tunes Customer's CIATSFABI advanced system generated through Prebuild process (FIG. 5) with Quick win (45) generates Company1_Alpha (46), Moderate complexity (47) generates Company1_Beta (48), complex generates Company1_Gama (50) and futuristic (49) generates Ideal_virtual (Latest version 62 and finally company1_ABG system (44) interact with customer's system to produce Ideal_virtual (Latest version 62), virtual_company (lower versions 40) and also support multi-national companies.
For multi-national companies (e.g. Company1 in NA 25, Company2 in Europe 26, Company3 in Asia 27) multiple CompanyN_ABG system will be generated based on customer's business system and Master CIATSFABI and Customer's CIATSFABI Advanced generated through Virtual Build (28) (FIG. 5).
The proposed Cognitive Intelligent Autonomous Transformation System Automation analyzer wizard (29) along with Prebuild ABG analyzer using Artificial Intelligence, Machine Learning/Robotic Process Automation, Neural Networks, analyze the Company profile, Existing system, Gaps in Best Practice Inter and Intra Industry to produce the ideal transformed target system called Virtual_company using the process VirtualBuild (28), as orchestrated by the Master proposed Cognitive Intelligent Autonomous Transformation System which is hosted in a datacenter.
Quick win (45) generates Company1_Alpha (46), Moderate complexity (47) generates Company1_Beta (48), complex generates Company1_Gama (50) and futuristic (49) generates Ideal_virtual (Latest version 62) and finally company1_ABG system (44) interact with customer's system to produce Ideal_virtual (Latest version 62), virtual_company (lower versions 40) and also support multi-national companies.
These Company1_ABG_Systems as orchestrated by Master proposed Cognitive Intelligent Autonomous Transformation System interact with existing Customer's information system, to generate various reports and constantly reduce the gaps with Ideal_virtual system (62) and strive to eventually become the chosen Virtual_company transformed target system (40).
Create PreBuild_ABG process using prebuild wizard (29) in conjunction with Master CIATSFABI fine-tunes proposed Customer's CIATSFABI—Basic (46), Advanced (48 50 62), Ideal_virtual (62) and virtual_company (40).
The proposed Cognitive Intelligent Autonomous Transformation System Cognitive Intelligent Automation Setup Wizard/Automation analyzer wizard (29) using Artificial Intelligence, Machine Learning/Robotic Process Automation, Neural Networks, analyze the Company profile (1), vision (2), mission (3), objectives (4), Strategy (5), Action Plan (6)), Existing system (12) (Enterprise Resource Planning, eCommerce, Customer Relationship Management, BW (7), Industry Solution (8), Core Business Process, Reports, Interfaces (RICEF) (9), Automation Opportunities (10), Priorities (11)), Gaps in Best Practice for Inter and Intra Industry (14) (Most used business process within the industry (18), Most used business process across the industries (14), Core business process (15), Automation opportunities (16), User Input Priorities (17), User Management Input Prioritization (24) (Infrastructure (19), Product portfolio choices (20), RICEF Choices (21), Automation opportunities (22), User Input Priorities (23), to produce the ideal transformed target system called Ideal_virtual (62) and can also be the transformed target system for the company called Virtual_company (40) using the process VirtualBuild, as orchestrated by the Master proposed Cognitive Intelligent Autonomous Transformation System which is hosted in a datacenter.
PreBuild_ABG process fine-tunes output of Cognitive Intelligent Automation Setup Wizard (from FIG. 5) which has License validation phase deciding the privileges, Discovery phase which identifies opportunity, platform specifics, finalize priorities and implementation phase that produces Ideal_virtual (latest version) virtual_company (lower versions) based on quick wins, complexity (moderate, complex, futuristic). Prebuild_ABG uses process from FIG. 5—Cognitive Intelligent Automation setup Wizard which has:
   License validation Phase (Machine Learning/Robotic Process Automation BOTS software robots/Virtual agents for Enterprise Resource Planning, eCommerce, Customer Relationship Management, BW, Manufacturing system, Product Lifecycle Management (PLM), Big Data Analytics depending on what licensing were purchased by customer.
   During Discovery Phase, identifies the Opportunity, understand platform specifics and finalize priorities based on benefits and customer input.
   During Implementation Phase, Produces a Quick wins (based virtual company solution, different virtual company solution depending on the complexity (Moderate Complex and Futuristic (. The virtual company solution is Ideal Virtual Enterprise Systems proposed Cognitive Intelligent Autonomous Transformation System (for complexity as Futuristic) and it can be the chosen transformed target system—virtual company proposed Cognitive Intelligent Autonomous Transformation System which can be Virtual_company on Quick wins/Moderate/complex/futuristic with entire process being monitored as part of governance process.
Cognitive Automation analyzer which reads company's existing configuration and company specific database, adapter modules to produce customer's CIATSFABI as the latest version available (Ideal_virtual) or one or more versions lower than the latest (Virtual_company)
The Cognitive Intelligent Autonomous Transformation System architecture using Artificial intelligence, Machine Learning, Deep Learning/Neural Networks, Robotic Process Automation, supported by SAP Leonardo Intelligent enterprise platform is designed to provide the necessary system, processes and technology to take existing information system and transform to provide the ideal ultimate information system for the customers, based on data driven machine learning and deep learning approach with lot of examples and training combined with process automation through explicit representations and rules aided by Robotic Process Automation and exception handling. Both Data driven Artificial intelligence and Process driven Artificial intelligence are controlled by a best practices Artificial intelligence database (Master proposed Cognitive intelligent automation solution/system) which itself is constantly being improved in each iteration which is officially released every 3 months.
In summary, FIG. 6 Create Pre-Build ABG system fine-tunes Customer's CIATSFABI advanced system generated through Prebuild process (FIG. 5) generates Company1_Alpha (46), Moderate complexity (47) generates Company1_Beta (48), complex generates Company1_Gama (50) and futuristic (49) generates Ideal_virtual (Latest version 62) and finally company1_ABG system (44) interact with customer's system to produce Ideal_virtual (Latest version 62). virtual_company (lower versions 40) and also support multi-national companies.

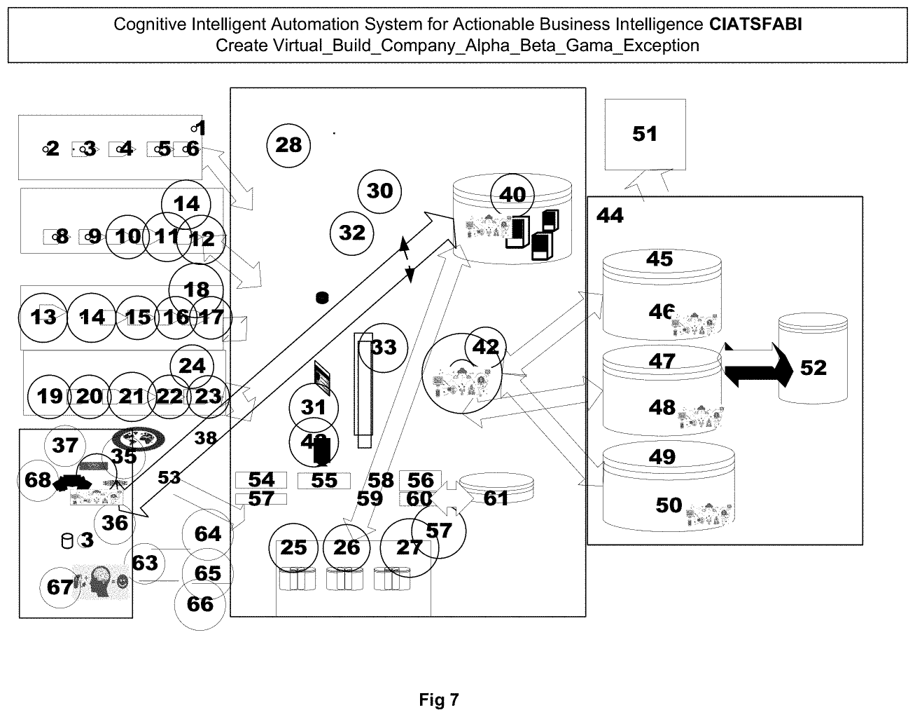

### FIG. 7—Steps to Create Prebuild ABG Systems—Exception Handling

| | |
|---|---|
| 1. | Company |
| 2. | Vision |
| 3. | Mission |
| 4. | Objectives |
| 5. | Strategy |
| 6. | Action Plan |
| 7. | Enterprise Resource Planning (ERR), eCommerce, Business |
| | Warehouse. |
| 8. | Industry Solution |
| 9. | Core Business Process, Reports, Interfaces (RICEF) |
| 10. | Automation Opportunities |
| 11. | Priorities |
| 12. | Existing Systems |
| 13. | Most used Business Process in the industry |
| 14. | Most used Business Process across the industries |
| 15. | Core Business Processes |
| 16. | Automation Opportunities |
| 17. | User input Priorities |
| 18. | Best Proactive Gaps -Inter-Intra Industry |
| 19. | Infrastructure |
| 20. | Product Portfolio Choices |
| 21. | RICEF Choices |
| 22. | Automation Opportunities |
| 23. | User input Priorities |
| 24. | User/Mgmt. Input-Prioritization |
| 25. | C1_ABGSystem |
| 26. | C2_ABGSystem |
| 27. | C3_ABGSystem |
| 28. | Prebuild Analyzer |
| 29. | Cognitive Intelligent Automation Prebuild Wizard |
| 30. | Company Configuration |
| 31. | Company Knowledgebase |
| 32. | Cognitive Automation Analyzer |
| 33. | Governance |
| 34. | Neural Networks (NN) |
| 35. | Artificial intelligence, Machine Learning, Deep Learning/ |
| | Neural Networks, |
| 36. | SAP Leonardo Intelligent enterprise platform |
| 37. | Master proposed Cognitive intelligent automation solution/ |
| | system |
| 38. | Releases every 3 months |
| 39. | External Events |
| 40. | Virtual Company proposed Cognitive Intelligent Autonomous |
| | Transformation |
| 41. | Robotic Process Automation_BOTS_0001 Robotic Process |
| | Automation |
| 42. | PreBuild_BOTS_proposed Cognitive intelligent automation |
| | solution/system |
| 43. | Monitor in Progress |
| 44. | Company1_ABGSystem |
| 45. | Quick wins with Robotic Process Automation Artificial intelli- |
| | gence NN |
| 46. | Company1_Alpha_proposed Cognitive intelligent automation |
| | solution/ |
| 47. | Moderate with Robotic Process Automation Artificial intelli- |
| | gence NN |
| 48. | Company1_Beta_proposed Cognitive intelligent automation |
| | solution/system |
| 49. | Complex with Robotic Process Automation Artificial intelli- |
| | gence NN |
| 50. | Company1_Gama_proposed Cognitive intelligent automation |
| | solution/ |
| 51. | Report to C level Executives - Checklist, Roadmaps. |
| 52. | Company Info Systems |
| 53. | Trigger Alerts for downloading latest version available |
| 54. | Potential Automation Scenarios 1-9999 |
| 55. | Predictive |
| 56. | Robotic Process Automation BOTS 0001 -Robotic Process |
| | Automation |
| 57. | Exception Robotic Process Automation_BOTS_1_to_999 |
| 58. | TRUE |
| 59. | FALSE |
| 60. | Attach Robotic Process Automation BOTS to EXCPTN_Robotic |
| | Process |
| 61. | Automation Exception handling with Deep Learning Wizard |
| 62. | Ideal Virtual Enterprise Systems proposed Cognitive intelligent |
| | automation |
| 63. | Implementation Approach |
| 64. | Brown-Field/System Conversion |
| 65. | Landscape transformation |
| 66. | Green-Field/New implementation |
| 67. | Digital Assistants |
| 68. | IndustryRef CIATSFABI |

FIG. 7 Create Pre-Build ABG system exceptions with Deep Learning wizard fine tunes Master & Customer's CIATSFABI the Ideal_virtual and virtual_company, initially using predictive scenarios and later with exceptions which is further resolved by Deep Learning wizard providing better automation in future.

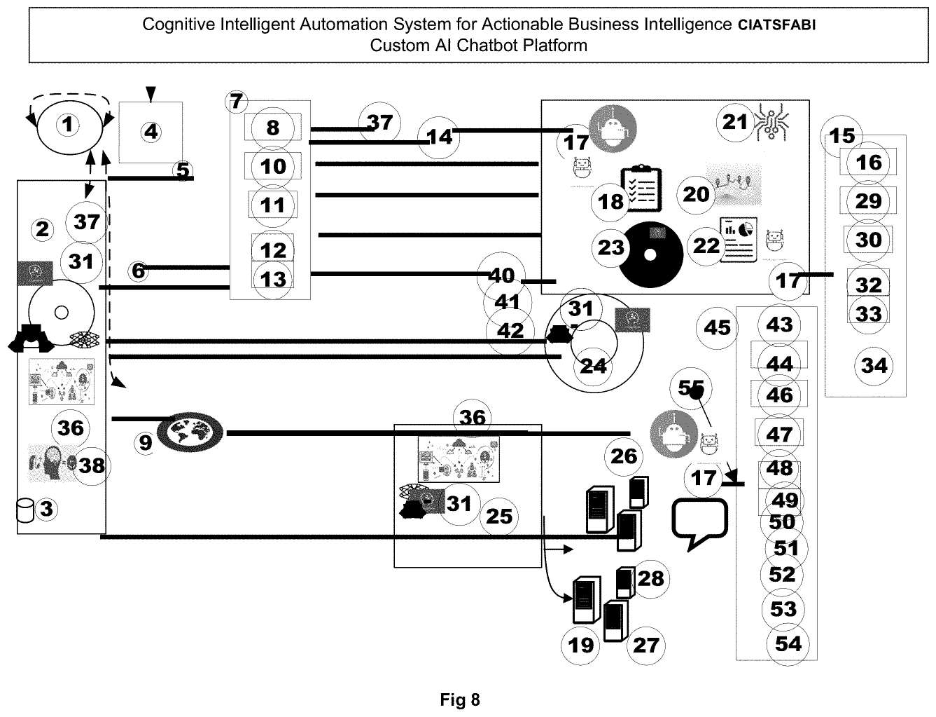

Most of the explanations for FIGS. 1, 2, 3, 4, 5 and 6 are also applicable to FIG. 7. Summary of Create Pre-Build ABG system exceptions (FIG. 7) have the following phases:
FIG. 7 Create Pre-Build ABG system exceptions fine-tunes Customer's CIATSFABI advanced system generated through Prebuild process (FIG. 6) generates Company1_Alpha (46), Moderate complexity (47) generates Company1_Beta (48) complex generates Company1_Gama (50) and futuristic (49) generates Ideal_virtual (Latest version 62) and finally company1_ABG system (44) interact with customer's system to produce Ideal_virtual (Latest version 62), virtual_company (lower versions 40) and also support multi-national companies.
For multi-national companies (e.g. Company1 in NA 25, Company2 in Europe 26, Company3 in Asia 27) multiple CompanyN_ABG system will be generated based on customer's business system and Master CIATSFABI and Customer's CIATSFABI Advanced generated through Prebuild analyzer (28) and Cognitive Intelligent Automation Prebuild wizard (29).
The proposed Cognitive Intelligent Autonomous Transformation System Automation analyzer wizard (29) along with Prebuild ABG analyzer (28) using Artificial Intelligence, Machine Learning/Robotic Process Automation, Neural Networks, analyze the Company profile, Existing system, Gaps in Best Practice Inter and Intra Industry to produce the ideal transformed target system called Virtual_company using the process VirtualBuild, as orchestrated by the Master proposed Cognitive Intelligent Autonomous Transformation System which is hosted in a datacenter.
Quick win (45) generates Company1_Alpha (46), Moderate complexity (47) generates Company1_Beta (48), complex generates Company1_Gama (50) and futuristic (49) generates Ideal_virtual (Latest version 62) and finally company1_ABG system (44) interact with customer's system to produce Ideal_virtual (Latest version 62), virtual_company (lower versions 40) and also support multi-national companies.
These Company1_ABG_Systems as orchestrated by Master proposed Cognitive Intelligent Autonomous Transformation System interact with existing Customer's information system, to generate various reports and constantly reduce the gaps with Ideal_virtual system (62) and strive to eventually become the chosen Virtual_company transformed target system (40).
Master & Customer's CIATSFABI Deep Learning wizard fine tunes the Ideal_virtual and virtual_company, initially using predictive scenarios and later with exceptions which is further resolved by Deep Learning wizard providing better automation in future.
Analyzing external events Master and customer CIATSFABI fine tunes virtual_company providing better intelligent system than the previous iterations.
The Customer's proposed Cognitive Intelligent Autonomous Transformation System is further fine-tuned by Automation_Exception_handling_with_Deep_Learning_Wizard (61) which initially uses predictive scenarios (55 56) for automation and if that may not work for this customer, the deep learning wizard understands the exceptions (57 60) and uses it in the future iterations to provide better automation capability.
Finally, all external events affecting the company will be analyzed and advice will be provided from the Master proposed Cognitive Intelligent Autonomous Transformation System to customer's proposed Cognitive intelligent automation solution/system, each iteration of the product will provide superior intelligence than the previous one.
In conclusion, Cognitive Intelligent Autonomous Transformation System (CIATSFABI) transforming existing customers information system (eCommerce, Enterprise Resource Planning, Customer Relationship Management, Analytics) to the proposed virtual target computing environment, every step of the way seamlessly, very similar to what autonomous cars take one from one place to the destination, except in this case, transformation of information system that run your business.
   FIG. 8 Master CIATSFABI Using AI Chatbot that Drastically Improves User Experience

| | |
|---|---|
| 1. | proposed Cognitive Intelligent Autonomous Transformation |
| | System etup Wizard |
| 2. | Master Cognitive Intelligent Autonomous Transformation System |
| | for actionable Business intelligence (Master CIATSFABI) |
| 3. | Cognitive Super DB |
| 4. | Customer's Existing Information Systems |
| 5. | License |
| 6. | Connectivity Test |
| 7. | Vendor specific end-to-end bot building platform |
| 8. | bot training |
| 9. | SWOT from External Events/Systems |
| 10. | bot building |
| 11. | bot testing |
| 12. | bot connector |
| 13. | bot analytics |
| 14. | business tasks |
| 15. | automate tasks with chatbots |
| 16. | natively integrated with the solutions using NLP |
| 17. | Digital Assistants - AI Chabot, RPA Bot |
| 18. | Checklist |
| 19. | Virtual Company (Customer's CIATSFABI) |
| 20. | Roadmap |
| 21. | Digital Assistants - AI scenarios |
| 22. | Reports |
| 23. | Artificial intelligence based proposed Cognitive Intelligent |
| | Autonomous Transformation System Adapters |
| 24. | proposed Cognitive Intelligent Autonomous Transformation |
| | System (Basic) |
| 25. | proposed Cognitive Intelligent Autonomous Transformation |
| | System (Advanced) |
| 26. | Existing Enterprise Systems |
| 27. | Virtual company Enterprise Systems |
| 28. | Ideal Virtual Enterprise Systems proposed Cognitive intelligent |
| | automation solution/system |
| 29. | Authentication API calls for calling bots |
| 30. | enable/disable bots |
| 31. | Artificial intelligence, Machine Learning, Deep Learning/Neural |
| | Networks, Robotic |
| 32. | training mode |
| 33. | restart mode |
| 34. | clearing conversation |
| 35. | Quick wins |
| 36. | SAP Leonardo Intelligent enterprise platform |
| 37. | IndustryRef CIATSFABI |
| 38. | Digital Assistants |
| 39. | Implementation Approach |
| 40. | Brown-Field/System Conversion |
| 41. | Landscape transformation |
| 42. | Green-Field/New implementation |
| 43. | Project |
| 44. | RPA Desktop studio |
| 45. | Intelligent RPA Factory |
| 46. | Digital Assistants - Online Information |
| 47. | Trigger |
| 48. | API |
| 49. | scenario |
| 50. | agent(s)/users |
| 51. | Intent |
| 52. | Expression |
| 53., | skill |
| 54. | API service configuration |
| 55. | Setup Connect Conversational AI web client |
| 56. | chat conversation |

Most of the explanations for FIGS. 1, 2, 3, 4, 5, 6 and 7 are also applicable to FIG. 8
Vendor specific end-to-end bot building platform (7) that includes bot training (8), bot building (10), bot testing (11), bot connector (12), bot analytics (13) helps business tasks (14) (guide users to the right page, answer FAQs, and automate tasks with chatbots (15) natively integrated with the solutions using NLP (16)) (e.g., SAP Conversational AI part of SAP Leonardo)
   1) Authentication API calls for calling bots (29)
   2) Admin/bot owner can enable/disable bots (30)
   3) Admin can set training mode (32) to automatic or manual allowing bot to use a training dataset
   4) Admin can set restart mode (33), thereby clearing conversation (34) of AI Chatbot
   5) Use cases: Customer Support/Guest Services, Sales and Marketing: 24×7 assistance, for Sales assistant, identify customer trends, align with department strategies, solving complex customer service challenges, creating new channels for commerce, integrated voice response systems, provide individualized contextual content, provide innovative services etc.
Master CIATSFABI using RPA Bot that are designed for intelligent automation, to mimic humans by replacing manual clicks, interpreting text in communications and/or making process suggestions to end users for repeatable processes by streamlining them making IT leaner, faster, substantial reduction in support costs and more strategic business innovations than to involve in manual repetitive tasks.
   1) Use cases: Service, Finance, Operations, Customer-support, HR, IT: Claim processing, Payment posting, AP, AR, service termination request from HR, IT ticket resolution
   2) Major Steps to create custom RPA Bot (e.g., SAP Intelligent RPA 2.0 Bot) with Conversational AI Chatbot.
      1) Create a Project (43) using RPA Desktop studio (44)
      2) Uploaded Project into Intelligent RPA Factory (45)
         Create a trigger (47) using one of the following:
         API (48) that allows an external application to execute a scenario (49) or process.
         Attended trigger deployed project is distributed to agent(s)/users (50) to run the jobs.
         Scheduled trigger jobs are created according to schedule you define in the trigger.
         Once trigger is setup, system will generate URL and trigger token
      3) Create new Chatbot using Conversational AI
         Create Intent (e.g., System) (51)
         Select one of possible expression (52) suggested (e.g., test integration, system integration check, please check system integrated etc.)
         Build and create new skill (53) “Integration Check”
         Double click on skill to setup trigger functionality
      4) Setup Integration of Intelligent RPA and conversational AI Bots
         Setup integration via API service configuration (54) with client id and secret
         Setup Headers with content-type as application/json and trigger token as was created from step 2.
         in the body, with Conversation ID is
         ${invocation_context.conversationd} and token as Conversational AI chat bot->settings
         Enter message content which will respond to Conversational AI, here I am entering output variable from IRPA bot sent to Conversational AI.Format is ${output.Output_Variables}. In this scenario, output field from Intelligent Robotic Process Automation bot is ws_text.
         validate the input and output parameters of an Intelligent Robotic Process Automation bot, go to project tab in Intelligent Robotic Process Automation Cloud Factory. Select the project you want and then click on scenarios. On right side of the window, find 1/O parameters.
      5) Setup Connect Conversational AI web client (55)
         Once complete connection setup process, it will generate a script which we need to copy and create a html file
      6) Test project by communicating with the custom Chatbot
         To run the bot, we must open the html file which we created in the above step. Here is the chat conversation (56) in below screenshot.

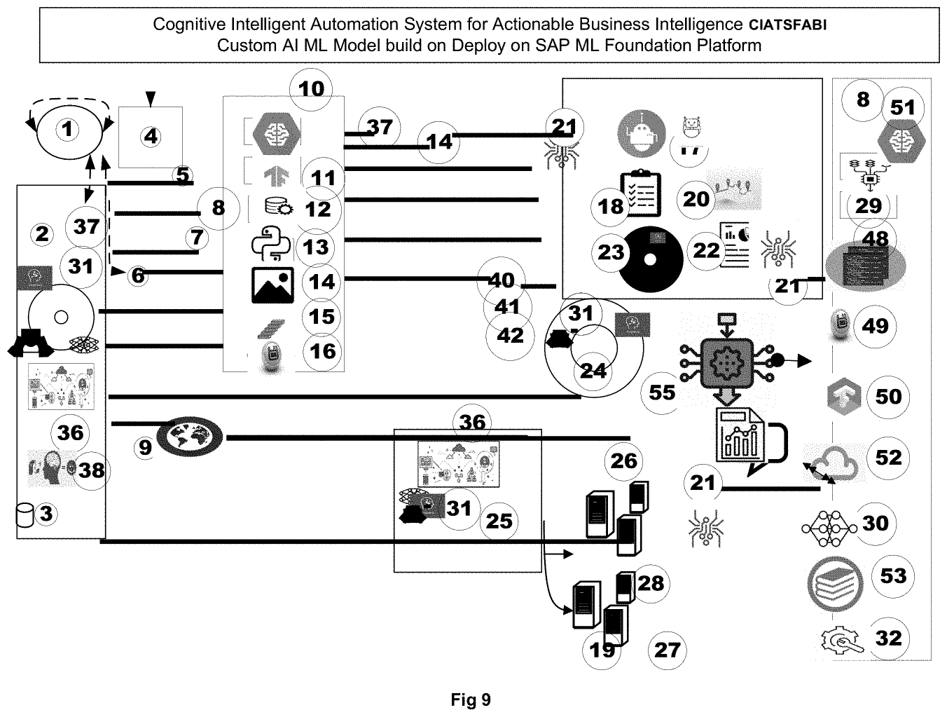

FIG. 9 Autonomous transformation of Customers COTS (e.g. SAP) business system by Master CIATSFABI—High-Level AI—Machine Learning with Tensor Flow Keras—Overview

| | |
|---|---|
| 1. | proposed Cognitive Intelligent Autonomous Transformation |
| | System Setup Wizard |
| 2. | Master Cognitive Intelligent Autonomous Transformation System |
| | for actionable Business intelligence (Master CIATSFABI) |
| 3. | Cognitive Super DB |
| 4. | Customer's Existing information Systems |
| 5. | License |
| 6. | Connectivity Test |
| 7. | pre-built AI-ML scenarios with pre-trained model |
| 8. | custom TensorFlow 2.0/Keras model |
| 9. | SWOT from External Events/Systems |
| 10. | AI-Machine Learning Platform setup |
| 11. | Build TensorFlow-Keras Model |
| 12. | Get the Data |
| 13. | Create Python programs |
| 14. | Read and manage the images (data_manager.py) |
| 15. | Create Model elements (model_elements.py) |
| 16. | Prepare model for saving (tf_serving.py) |
| 17. | Digital Assistants - AI Chabot, RPA Bot |
| 18. | Checklist |
| 19. | Virtual Company (Customer's CIATSFABI) |
| 20. | Roadmap |
| 21. | Digital Assistants - AI scenarios |
| 22. | Reports |
| 23. | Artificial intelligence based proposed Cognitive Intelligent |
| | Autonomous Transformation System Adapters |
| 24. | proposed Cognitive Intelligent Autonomous Transformation |
| | System (Basic) |
| 25. | proposed Cognitive Intelligent Autonomous Transformation |
| | System (Advanced) |
| 26. | Existing Enterprise Systems |
| 27. | Virtual company Enterprise Systems |
| 28. | Ideal Virtual Enterprise Systems proposed Cognitive intelligent |
| | automation solution/system |
| 29. | Describe, train and save the model (cifar10.py) |
| 30. | convolution Neural Networks (CNN) |
| 31. | Artificial intelligence, Machine Learning, Deep Learning/Neural |
| | Networks. Robotic |
| 32. | Tune hyperparameter |
| 33. | |
| 34. | |
| 35. | Quick wins |
| 36. | SAP Leonardo Intelligent enterprise platform |
| 37. | IndustryRef CIATSFABI |
| 38. | Digital Assistants |
| 39. | Implementation Approach |
| 40. | Brown-Field/System Conversion |
| 41. | Landscape transformation |
| 42. | Green-Field/New implementation |
| 43. | |
| 44. | |
| 45. | |
| 46. | |
| 47. | |
| 48. | code to train |
| 49. | save trained model |
| 50. | Deploy TensorFlow-Keras Model |
| 51. | SAP Leonardo ML Foundation platform |
| 52. | SAP Cloud Platform (SCP) |
| 53. | model repository (53) |
| 54. | Create model server |
| 55. | inference using gRPC |
| 56. | Deploy and create the model server (deployment.py) |
| 57. | Infer pictures (inference.py) |

Most of the explanations for FIGS. 1, 2, 3, 4, 5, 6,7 and 8 are also applicable to FIG. 9

Use cases:
3. Provide assistance to sales team when customer enquiries about an industrial part including show him image for the part or variants (similar images) by the sales inquiry screen or through chat window (using AI Chatbot (NCP))
4. Provide assistance to service parts ordering by showing the industrial part image to the technician servicing industrial machinery in the workshop.
   The above requires image classification model of say 60000 industrial parts with 10 different classes and the following describes the procedure to develop custom TensorFlow 2.0/Keras model, train the model and deploy in production in cloud foundry so the SAP Leonardo can provide appropriate user experience to utilize the AI trained image classification model.

### Master CIATSFABI (Transformation System) Uses Either

1. Pre-built AI-ML scenarios with pre-trained model (7) to provide unique AI based solutions across the enterprise on most of the business areas on major industry solutions as indicated in D, E, F, G or
2. Use custom TensorFlow 2.0/Keras model (8) with custom training data and save trained model; the trained model is then uploaded to SAP Leonardo's ML foundation platform to provide custom AI based solutions across enterprise for many industry solutions.

Building Custom TensorFlow Model and Deploying in SAP's ML Foundation Platform
1. AI-Machine Learning Platform Setup (10)
   Install TensorFlow 2.0 requires python 3.5-3.8, windows 10 64-bit pip version>19.0, latest GPU version at least 1.11.0
   Have global SAP cloud platform account (SCP), create space that contains instance of service ML-Foundation including service key.
2. Build TensorFlow-Keras Model (11)
   Build TensorFlow Model (Use case: Image classification) and save model as saved_model for inference. The deployment of model to production environment on cloud foundry using SAP's ML Foundation Service.
   2.1 Get the Data (12)
   To build image classification model with over 60000 industrials, items with color images 32×32 pixels belonging to 10 different classes. The images need to be downloaded from a location in cloud to say a directory cifar10 in your home directory.
   2.2 Create Python programs (13)
      Create 4 files separating the different tasks to build, run and save a TensorFlow model and store all our python files in the same folder we have stored the images in.
   2.2.1 Read and manage the images. (data_manager.py) (14)
      N: number of images in the batch
      H: height of the image
      W: width of the image
      C: number of channels of the image (ex: 3 for RGB, 1 for grayscale
      First and of special interest CifarimageProvider. This class loads the images and labels from file system and converts them.
      Load function the images from file system, but it does something important in addition, it converts the images. In the original format (NCHW) the three colors were separated, so we have three layers 32×32 each. This is transposed so we have a 32×32×3 tensor (NHWC) or each pixel has now all the color information. Finally, the integer value from 0 to 255 are converter into floats between 0 and 1 as deep networks tent to work better then. This is important to remember, as this is the format, we must provide the image data to our model and this will be the format an image needs to have for inference.
   2.2.2 Create Model elements—Provide some helper functions to define the model (model_elements.py) (15)
      Creating model elements
      Using helper functions to let us build up our model. This is quite useful as we want to build up a CNN having three identical layers, using batch normalization, average pooling and parameterized rectified linear unit as activation function.
   2.2.3 Prepare Model for saving—Provide some helper functions to save the model. (tf_serving.py) (16)
      Preparing Model Saving
      Bring your own Model (BYOM) uses TensorFlow serving. TensorFlow saved mode provides three types of APIs called Classify, Regress and Predict. The request implementation, which we will use in the second part, for the different APIs differ. PredictRequest on the one side expects values encoded via TensorProto.
      ClassificationRequest and RegressionRequest on the other side expect the data.
      Stf_serving.py. which contains two helper functions supporting us in saving our trained model. The first step we need to make is to create a folder to save our model in: he saved model builder requires to create this folder by its own, so you can't overwrite a model. To ensure we get always a new one we add a timestamp as last folder.
   Next, we define the PREDICT API that we will use for inference.
   The helper function has two parameter input_layer and prediction. The first one is a tensor that is the entry point in our TensorFlow graph. It describes how the model expect the input and where to inject the input into the graph. The second one describes the output of the model, so on the one hand how the output looks like and on the other hand it gives the node in our graph from which the output shall be taken. We will see that when we build your model.
   The API definition itself is called signature. As we build a prediction API our signature has one input and one output parameter. The names, ‘images’ and ‘scores’, are given by us
   2.2.4 Building up the model—Describe, train and save the model.(cifar10.py) (29)
   The script will be described in four blocks. Giving the change to explain each.
   2.2.4.1 As mentioned we build a convolution Neural Networks (CNN) (30) for image classification. This model shall have three convolutional layers and one fully connected one. In the first block we start with declaring some hyperparameter:
   2.2.4.2 Tune the hyperparameter (32) as appropriate:
   2.2.4.3 we define the path below the home directory to the folder the model shall be saved in.
   2.2.4.4 In the next block, we create two functions to inform us about the progress during the training. First one to determine the test accuracy and second one to have a progress indicator.
   2.2.5 Now we can Finalize building up the model (47)
      1. Give your variables and placeholder proper names. Otherwise, if something went wrong during deployment or interference, you will get problems finding the error.
      2. The shape of the placeholder x and y_start with None. This is important, as it let TensorFlow accept any batch size including batch size one, which we need if we want to infer later in production single images.
      3. During inference we do not want to provide values for the placeholder training and keep_probe. So, we use placeholder_with_default as default value we choose the one we want to have during inference.
   2.2.6 Finally, we have code to train (48) and save the trained model (49).
      Please look at three statements:
      1. builder=saved_builder.SavedModelBuilder(tfs.build_path(EXPORT_DIR)): This statement gives us the Saved Model Builder.
      2. add_meta_graph_and_variables( . . . : This is maybe the most interesting statement. We provide the session that is running, so the saver knows the graph and has access to all current Variable values. We tag our model to be foreseen for serving and provide a list of signature definitions. You should notice that we give every signature a name and that we can define a default signature, for the scope of this tutorial they are the same.
      3. save( ): Finally save our trained model.
      Now we have all the python code is there to train our model,
   2.2.7 run cifar10.py. We can do that e.g., by opening a console, navigate to the folder you create the python files in and call e.g., python cifar10.py.
      If the python program has finished, you may see something like this: achieved ˜85% accuracy for the test data and it took round about 22 seconds per epoch. (entire dataset is passed forward and backward in Neural network once).
      In case you have halved the number of filters for CNN (C1, C2 and C3) it is likely that you get lower accuracy (83%):
      There is a last thing that we need to do, we have to go to the folder the TensorFlow model was saved to. Here you should find two things. A file that contains the model and a folder for the variables:
      Variables and
      Saved_model.pb
      Both need to be zipped to cifar10.zip
3. Deploy TensorFlow-Keras Model (50) on SAP Leonardo ML Foundation platform (51)
   3.1 Interacting with SAP Cloud Platform (SCP) (52)
   Four tasks that are provided by ML foundations by REST APIs. Create scp_access.py.calls the ML Foundation APIs that we need (e.g., loadjson_from_file function to load service_key, generate_bearer function takes the URL and service key credentials to request a bearer). All services can be looked at SAP's API hub.
   3.1.1 Upload all versions of the model to the model repository (53) including one model used to retrain services.
      Function upload_model has a. model_name, token (bearer token), service_urls (end-points of ML foundation service taken from service_key), model_path path to the model.zip file.
   3.1.2 Create model server (54) running our custom model.
      Creating model server creates container instance and features are described in JSON body (enableHttpEndpoint, modelRuntimeId: models, resourcePlanId, replicas). For further details you may refer to API hub.
   3.1.3 Remove old model server running outdated versions for the model. we also want to retrieve information about our model server and, if they are no longer needed, delete them.
   3.1.4 Call model server for inference using gRPC (55) (open-source remote procedure call and uses http-2 for transport, protocol buffers as the interface description language and provides features such as authentication, bidirectional streaming and flow control, blocking or nonblocking bindings, and cancellation and timeouts).
      Helper function_to_float that converts image data from integer values to floats
      Function that calls REST service with parameters (endpoint (endpoint of the model server), signature_name (name defined during our training), image_path (path to the images in our machine)
   3.2 Deploy and create the model server (56) (deployment.py)
      We need to store the model in the model repository and deploy and create model server.
   3.2.1 create bearer token
   3.2.2 look at existing model_server instances using our model and start creating a new instance. The creation of model server merely creates a job that creates the model server and hence the status of model server creation need to be checked.
   3.2.3 If all goes well, delete old model_server instances.
   3.2.4 Once model server is up and running, we can perform inferences on pictures.
   3.3 Infer pictures (57) (inference.py)
   3.3.1 Retrieve information about model server (e.g., end-point of model server)
   3.3.2 Call server using gRPC.
   3.3.3 Call server using REST service.
      3.3.4 Running interence.py identifies the category be it a machinery (Air-Conditioner or Lathe etc.)
   3.5 The above inference will then be used in Master SAP Leonardo applications to provide unique customized solutions based on AI both industry specific and enterprise-wide solutions.

1. Cognitive Intelligent Autonomous Transformation System for Actionable Business Intelligence (CIATSFABI) comprising:
An existing customer business information system based on Commercial off Shelf application (COTS);
CIATSFABI system architecture supports Artificial intelligence (AI), Robotic Process Automation (RPA), Internet of Things (IoT), Machine Learning (ML), Natural language processing (NLP), Speech and image recognition, Deep Learning (DL) using neural networks (NN), In-memory computing;
CIATSFABI combines artificial intelligence including robotic process automation for program-based transformation automation and cognitive computing through data-driven predictive transformation automation scenarios including exception handling in a single operating environment using the same sets of data—existing customer system to be a self-evolving Cognitive Intelligent Autonomous Transformation System which will be the target version;
CIATSFABI's data preparation module reads from configuration database of current business system;
CIATSFABI transforms to recommended version supported for the industry and company while protecting all existing configuration, master, transaction, historical data and features of current system, converting data where needed;
CIATSFABI interacts with customer using customer's inputs to iteratively design and prototype transformed target system, converting the existing system data where necessary, that works with this version;
CIATSFABI transforms in series of iterations—starting with Basic transformation based on customer selection of Quick win and Advanced transformation based on customer selection of complexity desired—moderate or complex or futuristic;
CIATSFABI monitors progress of transformation of both the system and data, real-time;
CIATSFABI continuously improves transformation based on predictive automated transformation scenarios and exceptions supported through deep-Learning using neural networks;
CIATSFABI continuously improves transformation based on predefined AI Machine Learning scenarios and Custom AI Machine Learning t scenarios supported through deep-Learning using neural networks, python programming, TensorFlow and Keras;
CIATSFABI produces actionable reports, checklists, roadmaps and gaps on existing initiatives vs proposed initiatives, generated for existing system and proposed;
CIATSFABI produces actionable reports at every stage of transformation evolution of the proposed transformed target system;
CIATSFABI produces actionable reports on gaps to assist customer decide to approve transformation to new system;
CIATSFABI produces actionable reports on strategic, tactical and operational execution;
CIATSFABI supports machine learning, robotic process automation, artificial intelligence, deep learning using customized neural networks, Internet of Things, Block-chain, In-memory computing, Big Data Analytics, image recognition, speech recognition, cognitive intelligent automation and workflow-based exception handling;
CIATSFABI supports hosting in cloud and for customer specific transformed target system on cloud or on-premise where possible;
CIATSFABI continuously monitors internal and external events which triggers reports to assist top management;
CIATSFABI proposed will be actualized by IT team following their own policies, procedures and change management and fine-tuned CIATSFABI (actual) system will be the customer's target system;
CIATSFABI is synchronized and fine-tuned with Customer's transformed target system to assist in future iteration and quality of proposed transformed target system.

2. Cognitive Intelligent Autonomous Transformation System for Actionable Business Intelligence(CIATSFABI aka Master CIATSFABI that transforms customer's existing system to eventual transformed target system aka Customer's CIATSFABI) in accordance with claim 1, wherein CIATSFABI provides actionable business Intelligence (BI) reports, checklists & roadmaps to all C level executives, board of directors and all executive management on business intelligence, information system architecture, existing products & services, corporate compliance and opportunity assistance including cloud migration readiness roadmap.

3. CIATSFABI in accordance with claim 1, wherein CIATSFABI provides actionable business intelligence reports that include predicting from present to 1 or 2- or 5-years new infrastructure needs, new products & services, new mergers & acquisition opportunities, predicting & mitigating emerging corporate vulnerabilities to board of directors (BoD), top management, business system users and stakeholders.

4. CIATSFABI in accordance with claim 1, wherein CIATSFABI provides actionable intelligence on corporate governance for strategic, tactical, operational execution to board of directors, top management, business system users and stakeholders.

5. CIATSFABI in accordance with claim 1, wherein CIATSFABI identifies the automation opportunity within the current application system comparing with the best practices within same industry and/or across all industries and other companies in the same industry, on automation opportunities.

6. CIATSFABI in accordance with claim 1, wherein CIATSFABI identifies the new business processes, and/or other new software solution extensions provided by COTS that might be enabled based on the best practices within same industry and/or across all industries and other companies in the same industry, on new process and software opportunities.

7. CIATSFABI in accordance with claim 1, wherein CIATSFABI transforms customer's existing system to transformed target system as intelligent enterprise across all business areas with real-time intelligence and alerts provided 24×7, on opportunities and threats.

8. CIATSFABI in accordance with claim 1, wherein CIATSFABI analyzes external events including change in market place, laws, technology and tax-rates affecting the company, transforms to new proposed transformed target system taking advantage of external events.

9. CIATSFABI in accordance with claim 1, wherein CIATSFABI in interaction with existing system, identifies scope of transformation in various business areas along with phased implementation.

10. CIATSFABI in accordance with claim 1, wherein CIATSFABI identifies ultimate transformed target system available in the industry for the specific operating system, database and server of customer from vendor of COTS.

11. CIATSFABI in accordance with claim 1, wherein CIATSFABI identifies capability maturity ranking real-time identifying the gaps in their existing system and business initiatives comparing the same with proposed transformed target system.

12. CIATSFABI in accordance with claim 1, wherein CIATSFABI produces comprehensive step-by-step phased implementation checklist for IT, top management, Project team and Business teams, to rollout customer's transformed target system.

13. CIATSFABI in accordance with claim 1, wherein CIATSFABI monitors the internal events including company or organizational milestones, new product launches, new incentive programs, BoD/Shareholder meetings, significant external world events including impending political/economic/legal/tax rate changes mergers & acquisitions, new technology innovations and produces Strength, weakness, opportunity, threats (SWOT) analysis reports that can significantly bring benefit to the company and its stakeholders.

14. CIATSFABI in accordance with claim 1, wherein CIATSFABI transformed target system that supports and aligns with corporate mission, goals & objectives of the customer.

15. CIATSFABI in accordance with claim 1, wherein CIATSFABI, validates license purchased by customer and decides all privileges of transformations available in transformed target system.

16. CIATSFABI in accordance with claim 1, wherein CIATSFABI, learns continuously with each generated transformed target system—starting with initial first-cut Basic transformation based on customer selection of Quick win and best-in-class Advanced transformation based on customer selection of complexity desired—moderate or complex or futuristic, supported by deep learning using neural networks.

17. CIATSFABI in accordance with claim 1, wherein CIATSFABI, on customer's request, synchronizes and fine-tunes CIATSFABI based on finalized customer's transformed target system so better transformation of customer's system in subsequent iterations or scheduled release of CIATSFABI.

18. CIATSFABI in accordance with claim 1, wherein CIATSFABI, produces transformation of popular COTS for all major industries world-wide and CIATSFABI rolls out autonomously/semi-autonomously once customer approves target version.

19. CIATSFABI in accordance with claim 1, wherein CIATSFABI produces custom methodology of transformation implementation for any industry and for various versions of COTS.

20. CIATSFABI in accordance with claim 1, wherein CIATSFABI transforms better, existing system using Deep Learning, Artificial intelligence, Machine Learning, Robotic Process Automation, block-chain, In-memory computing, Big Data Analytics, Internet of Things and different adapter modules.
